(19) United States
(12) Patent Application Publication
(10) Pub. No.: US 2015/0073959 A1
(43) Pub. Date: Mar. 12, 2015

(54) Collaborative Financial Management

(71) Applicants: Eric Connors, Pleasanton, CA (US); Jose Antonio Buraschi, Union City, CA (US); Katy Gibson, San Anselmo, CA (US); Vinay Nagaraj, San Jose, CA (US)

(72) Inventors: Eric Connors, Pleasanton, CA (US); Jose Antonio Buraschi, Union City, CA (US); Katy Gibson, San Anselmo, CA (US); Vinay Nagaraj, San Jose, CA (US)

(21) Appl. No.: 14/481,833

(22) Filed: Sep. 9, 2014

Related U.S. Application Data
(60) Provisional application No. 61/875,635, filed on Sep. 9, 2013.
(60) Provisional application No. 61/876,146, filed on Sep. 10, 2013.

(51) Int. Cl. G06Q 40/00

(52) U.S. Cl. CPC G06Q 40/00
USPC 705/35

(57) ABSTRACT

Methods, systems, and apparatus, including computer programs encoded on computer storage media, for collaborative financial management, including instructions to display in a first region of a display of the device a name of a currently selected financial collaboration group out of multiple financial collaboration groups to which a user of the device is a member. Instructions to receive data representing events associated with the currently selected financial collaboration group, each event of the being one of a multiple of types. Instructions to display in a second region of the display of the device an ordered list of the events, wherein each item in the ordered list includes a visual indicia of an event type for the event corresponding to the item. Instructions to select a different financial collaboration group in response to a touch input in the first region of the display of the device.

### CROSS REFERENCE TO RELATED APPLICATIONS

This application is a non-provisional of and claims priority to U.S. Provisional Patent Application No. 61/875,635, filed on Sep. 9, 2013, and U.S. Provisional Patent Application No. 61/876,146, filed on Sep. 10, 2013, the entire contents of both of which are hereby incorporated by reference.

### TECHNICAL FIELD

This specification relates to collaborative management of personal finances.

### BACKGROUND

As the Internet has grown in popularity, users are turning to services provided over the Internet to help manage their finances. These services can be provided by financial institutions, such as banks or credit card companies, or by account aggregators that aggregate and present user-specific financial information from one or more financial institutions. Users typically provide a user name and password to webpage(s) maintained, or mobile applications provided, by a financial institution or an account aggregator. From the webpage(s) or mobile application, the user can access online banking, electronic bill payment, account aggregation, and other online financial services.

A financial institution can provide access to a user's financial information, and provide other services or functionality. For example, a user can view his/her financial statements of an account with the financial institution, transfer balances to a different account or financial institution, and apply for loans with the financial institution. A user can also electronically pay bills by transferring money from an account to a creditor through the Internet. The financial institution can include functionality to schedule bill payments at a later date, or allow a user to identify periodic financial obligations and authorize payments on the periodic dates.

### SUMMARY

This specification describes technologies relating to collaborative management of personal finances. Users can interact with a financial collaboration server system to create financial collaboration groups with other users for a variety of purposes. The membership of the group and the type of information shared and rights granted to each user can vary from group to group, depending on how each group is set up by the users.

For example, users can create a financial collaboration group for purposes of collaborating on shared personal finances. For example, a couple can create a financial collaboration group that allows them to view financial information, e.g., all transactions, involving their respective financial accounts. The couple can interact with each other through the financial collaboration server system by, for example, tagging or commenting on individual financial transactions, setting shared goals, and sharing expenses.

In another example, users, e.g., roommates or individuals sharing costs for a joint trip, party or other event, can create a financial collaboration group to collaborate with each other through the financial collaboration server system to share expenses. For example, users in such a financial collaboration group can interact with the financial collaboration server system to request reimbursement from other users for a shared expense, e.g., reimbursement for rent paid or fuel-related expenses.

In another example, users can also create financial collaboration groups that are based on achieving a shared goal. For example, multiple users, e.g., parents and grandparents can interact with the financial collaboration server system to satisfy a shared goal of paying for a child's college education. Each user in the financial collaboration group can contribute a certain amount of funds toward the shared goal. Similarly, siblings can create a financial collaboration group that is based on providing continuing long-term care for a parent. Each sibling can contribute a certain amount of funds toward the shared goal, e.g., contributing toward the costs of providing continuing long-term care.

In another example, users can create financial collaboration groups in order for some users to monitor the finances of other users. For example, a child and an aging parent can establish a financial collaboration group that permits the child to monitor financial accounts of the parent. The child could monitor the parent's financial accounts for suspect transactions and respond to alert reminders regarding bills that need to be paid.

Depending on the type of financial collaboration group, the financial collaboration server system can provide a graphical user interface that displays one or more of a status of the users' respective financial accounts, financial transactions associated with the users' respective financial accounts, shared goals, shared expenses, and communications between users on various topics, e.g., particular financial transactions, bills, or expenses, to name a few examples. As described below, users can interact with the financial collaboration server system to automate certain financial transactions including, for example, automating contributions toward a shared goal.

In general, one aspect of the subject matter described in this specification can be embodied in computer program products comprising instructions encoded in a non-transitory computer readable medium to cause a processor of a device to display in a first region of a display of the device a name of a currently selected financial collaboration group out of a plurality of financial collaboration groups to which a user of the device is a member; receive data representing a plurality of events associated with the currently selected financial collaboration group, each event of the plurality of events being one of a plurality of types; simultaneously with the display of the name of the currently selected financial collaboration group in the first region of the display of the device, display in a second region of the display of the device an ordered list of the plurality of events, wherein each item in the ordered list includes a visual indicia of an event type for the event corresponding to the item; and select a different financial collaboration group of the plurality of financial collaboration groups in response to a touch input in the first region of the display of the device.

These and other embodiments can each optionally include one or more of the following features. The ordered list is ordered by time of the event. Instructions to simultaneously with the display of the ordered list in the second region, display in a third region of the device display a user selectable option to create an event associated with the currently selected financial collaboration group. The user selectable option to create the event comprises a drop-down menu including options to add a transaction and to add a comment to the plurality of events. The plurality of event types comprise a transaction type, the transaction type indicating a financial transaction shared with the financial collaboration group by a member of the financial collaboration group. Instructions to display, within an item of the transaction type, a user-selectable option to add a comment to the event. The plurality of event types comprise a reimbursement request type, the reimbursement request type indicating a financial transaction to be reimbursed by the user of the device. Instructions to display, within an item of the reimbursement request type, a user-selectable option to add a comment to the event. Instructions to display, within an item of the reimbursement request type, a user-selectable option to settle up the transaction. The plurality of event types comprise an invitation vote type, the invitation vote type indicating an invitation to a new user to join the financial collaboration group.

Particular embodiments of the subject matter described in this specification can be implemented so as to realize one or more of the following advantages. Multiple individuals can create financial collaboration groups to facilitate management of their shared finances through one interface. The multiple users in the financial collaboration group can access the interface to view and comment on each other's financial transactions. The users in the financial collaboration group can also interact with each other through the interface to create and contribute to shared goals. Further, the users in the financial collaboration group can interact with each other through the interface to manage shared expenses, e.g., by requesting reimbursement from other users or reimbursing other users.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system used for financial collaboration.

FIG. 2A illustrates a first example method for collaborative financial planning.

FIG. 2B illustrates a second example method for collaborative financial planning.

FIG. 3 is a schematic diagram of an example of a generic computer system.

FIG. 4 illustrates an example interface displaying collaborative financial planning options available to a user in a financial collaboration group.

FIG. 5 illustrates an example interface displaying financial collaboration groups.

FIGS. 6A-G illustrate an example interface for reimbursement for a financial transaction.

FIGS. 7A-7D illustrate an example interface for managing a third-party's financial transactions.

FIG. 8 illustrates an example interface and describes methods of interacting with the interface.

FIG. 9 illustrates an example interface.

FIG. 10 illustrates an example interface for creating a circle.

FIG. 11 illustrates an example interface that includes information related to a circle.

FIG. 12 illustrates an example interface that displays functionality available to users in a circle.

FIG. 13 illustrates an example interface for sharing a financial account.

FIG. 14 illustrates an example interface to request a reimbursement from one or more users.

FIG. 15 illustrates an example interface for viewing money owed to a user and money owed by the user.

### DETAILED DESCRIPTION

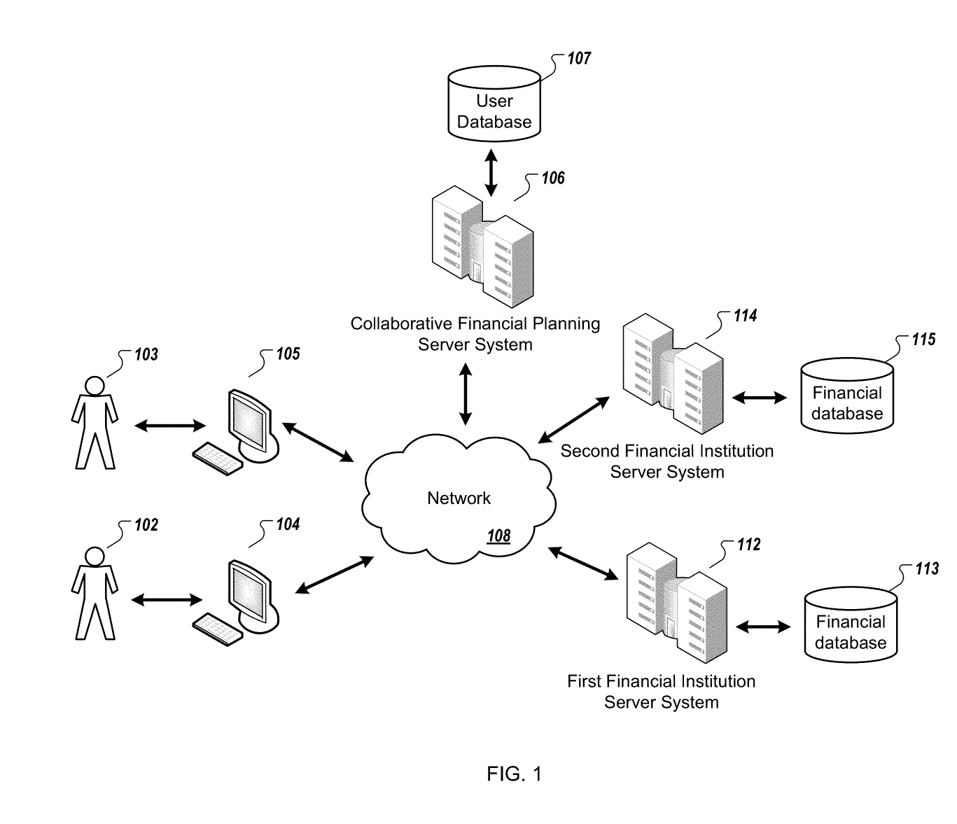

FIG. 1 illustrates an example system 100 used for financial collaboration. One or more user devices, e.g., the user devices 104 and 105, a financial collaboration server system 106, and one or more financial institution server systems, e.g., the financial institution server systems 112 and 114, are connected through a network 108. Each user device 104 and 105, the financial collaboration server system 106, and each financial institution server system 112 and 114 can include one or more computing devices.

The financial collaboration server system 106 executes software to provide services to users, e.g., users 102 and 103, of the financial collaboration server system 106, e.g., a user 102 can create a user account with the financial collaboration server system 106. The services can include aggregating financial information associated with a user's financial accounts with one or more financial institutions, and providing financial information for presentation on a user device of the user. Financial accounts of a financial institution can include savings accounts, checking accounts, credit card accounts, investments, bills, rewards, loans, and mortgages.

In particular, the financial collaboration server system 106 provides functionality for a user to collaborate with other users on one or more of their personal finances, e.g., managing financial accounts shared with other users, achieving shared financial goals, managing shared expenses, and analyzing shared spending. A user 102 can collaborate with another user 103 by creating and joining a financial collaboration group.

A financial collaboration group is a group of two or more users that can effect a financial purpose. That is, roommates can create a financial collaboration group to effect the payment of rent. A parent and child can create a financial collaboration group to effect the payment of the child's college expenses. A financial advisor and businessperson can create a financial collaboration group to effect the financial health of the businessperson, e.g., the financial advisor can view all financial transactions of the businessperson and offer advice on ways to save money, investments to make, and so on.

Users in a financial collaboration group can share financial information with the remaining users. Financial information can be obtained from financial accounts a user has aggregated. For instance, a user can share particular financial transactions, expenses incurred, upcoming bills, and so on. A user can also share a financial account, e.g., a checking, savings, credit card account, with the remaining users. Sharing a financial account provides the remaining users with the ability to perform one or more operations on the financial account that is shared. For instance, the remaining users can access the financial account to view financial transactions in the financial account. Additionally, a user can provide control of the financial account along with access, e.g., a remaining user can transfer money from his/her own financial account to the financial account that is shared, or a remaining user can transfer money out of the financial account that is shared. Financial collaboration groups are described further below.

User devices, e.g., user devices 104 and 106, can include computers, tablets, mobile devices, wearable electronics, or hybrids. As described above, a user device can receive financial information for presentation on the user device from the financial collaboration server system 106. In some implementations the user device can execute an application, e.g., an application downloaded from an application store, that is in communication with the financial collaboration server system 106. An application on a user device is a piece of software installed on the user device. The application can access features of the hardware of the user device, e.g., a touch screen, a microphone, infra-red sensor, finger print reader, and so on, through the use of software on the user device.

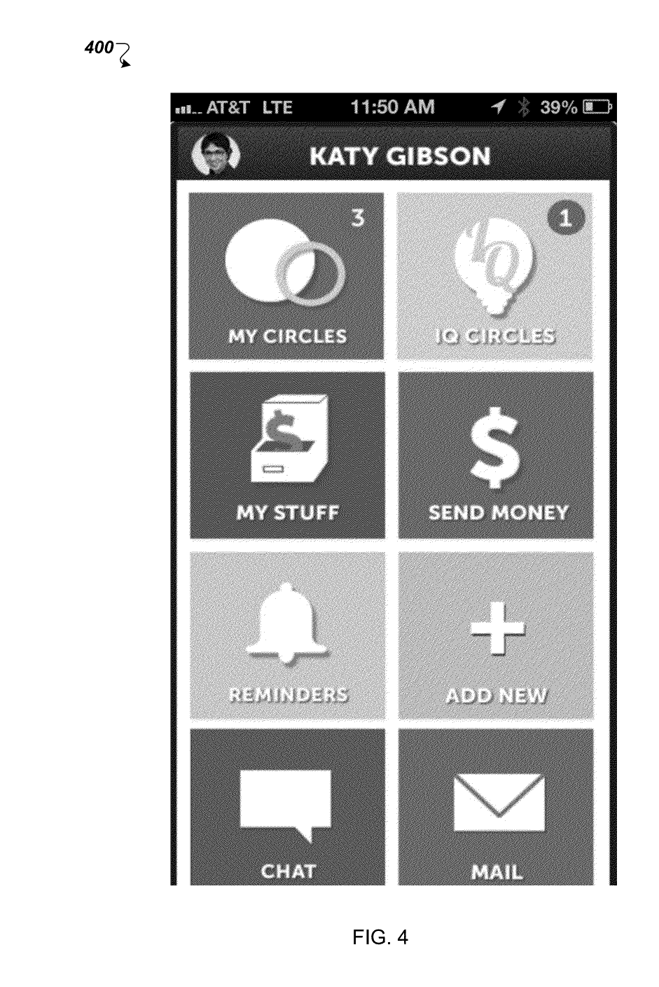

In some implementations the user device can obtain information from, and provide information to, the financial collaboration server system 106 by accessing a web site presented on the user device, e.g., in a web browser. The website can be provided from the financial collaboration server system 106, or an outside server system in communication with the financial collaboration server system 106. Examples of user interfaces provided for presentation on a user device are described below, with respect to FIGS. 4-15.

User accounts with the financial collaboration server system 106 are stored in a user database 107. In some implementations each user can have an associated user identifier, with one or more tables, e.g., flat tables, in the user database 107 identified by the user identifier. Each user account can include financial information associated with the user of the user account, e.g., financial information from financial accounts with financial intuitions. Financial information can be encrypted in the user database 107, e.g., encrypted using SHA-2, SHA-3, and so on. Additionally, information identifying a financial collaboration group can be stored in the user database 107, described below.

The financial collaboration server system 106 is in communication with one or more financial institution server systems, e.g., the financial institution server system 112 and 114. Each financial institution server system 112 and 114 is associated with a financial institution, e.g., an institution that can provide financial services, deal in financial instruments, lend resources, invest money, and store money. Examples of financial institutions include banks, brokerage firms, credit card companies, credit unions, and savings and loan associations.

Additionally, each financial institution server system can store financial information associated with financial accounts of the financial institution, e.g., in a respective financial database 113 or 115 in communication with the financial institution server system. A user can have a financial account with the financial institution when, for example, the user deposits money at the institution or has a line of credit provided by the financial institution.

Financial information can include customer data, account data, e.g., financial institution data, payee data, transaction data, and so on.

Customer data includes a user's name and contact information, e.g., address, telephone number, and email address. Customer data can also include the user's password or personal identification number (PIN) that authorizes access to money or information from the financial institution.

Financial institution data includes the financial institution's name and address, the financial institution's ABA or routing number, a debit card number associated with the financial institution, and credit card numbers and information. For instance, a user can have a debit card from a checking account associated with a financial institution.

Payee data includes a name of the payee, e.g., a business, a person that receives money. Additionally, payee data can include a classification of a payee, e.g., restaurant, person, utility, hardware store, and so on Transaction data can include an identifier for each individual transaction, the parties in the transaction, e.g., payor and payee (typically identities of both parties would be stored, but in some situations such as a record of a check, the payee may be left undefined), the amount of the transaction, and the date of the transaction.

Alternatively or in addition, financial information associated with financial accounts of financial institutions can be stored in the user database 107 in communication with the financial collaboration server system 106. For instance, a user can request to have financial account information at one or more financial institutions aggregated and stored in the user database 107 by the financial collaboration server system 106. The financial collaboration server system 106 can receive financial information and customer data from financial institutions, e.g., from associated financial institution server systems, and store the information in the user database 107.

In cases where the financial collaboration server system 106 receives or has access to personal or sensitive information, e.g., customer data or financial information, the financial collaboration server system 106 is configured to have privacy protections. For instance, users can limit the data that the financial collaboration server system 106 has access to, or can store. Additionally the financial collaboration server system 106 can encrypt and anonymize appropriate information.

Additionally, a user's financial information associated with financial accounts of financial institutions can be stored locally on the user's user device, e.g., user device 104. Financial information that is recent, e.g., financial information in the past 1 month, 2 month, or 3 months, can be stored on the user device. In this way the user device can receive aggregated financial information, and provide it for presentation on the user device without having to receive it over a network, e.g., the Internet.

A user, e.g., user 102, of a user device, e.g., user device 104, can provide a request to the financial collaboration server system 106 to aggregate one or more of their financial accounts at respective financial institutions. Upon receipt of the request, the financial collaboration server system 106 obtains authentication information, e.g., a user name and password, associated with each respective financial institution and provides it to a respective financial institution server system. The user's 102 financial information is then received by the financial collaboration server system 106 from each financial institution server system.

After providing the request, the user's 102 financial information can be provided for presentation on the user device 104, e.g., in a user interface. In some implementations the financial collaboration server system 106 can provide only the most recent financial information, e.g., this month's transactions, account balances, debits, credits, and so on.

As used in this specification, account aggregation involves collecting financial information from a user's financial accounts with at least one financial institution by a computer system of an entity other than the user or the financial institution at which the user has the financial account. This information is optionally stored in a user database 107 in communication with the financial collaboration server system 106, or on one or more financial institution server systems, e.g., the systems 112 and 114.

Financial information can be collected in different ways. In some implementations, information is received directly from the financial institution server systems 112 and 114. In some implementations, the financial collaboration server system 106 executes one or more agents to extract user-specific financial information from various webpages and other consumer-accessible channels, for example public Open Financial Exchange (OFX) feeds.

An agent is a computer program that extracts financial information by, for example, screen scraping by parsing the HyperText Markup Language (HTML) code of webpages and identifying relevant information, or by extracting financial information from data feeds. A webpage is a block of data identified by a URL that is available on the Internet. One example of a webpage is a HTML file. Webpages commonly contain content; however, webpages can also refer to content outside the webpage that is presented when the webpage loads in a user's web browser. Webpages can also generate content dynamically based on interactions with the user. A public OFX feed is a stream of financial data sent to another computer, for example, over the Internet, by a server of one or more financial institutions, where the data is formatted in accordance with the Open Financial Exchange standard. Other methods of gathering financial information are also envisioned.

When collecting financial information about a user 102 from a particular financial institution, the financial collaboration server system 106 can access the user's financial account with the particular financial institution, e.g., by providing the user's login credentials to the associated financial institution server system directly, or by inserting the credentials into a website provided by the financial institution server system. The login credentials can include, for example, a login and password, data for satisfying multi-factor authentication, and one or more public-key infrastructure certificates. After providing credentials, the financial collaboration server system 106 can receive information from the associated financial institution server, or can extract information from a website provided by the financial institution server system. Extraction can include identifying financial information using pattern matching, e.g., identifying occurrences of account numbers and associated dollar amounts, transactions, and so on.

The financial collaboration server system 106 can perform services with one or more of the financial institutions from which a user's financial account information has been aggregated. For instance, the user 102 can request to transfer money between two financial institutions, e.g., a user can pay a bill from one financial institution with money from another financial institution, or transfer money from a checking account to a savings account. To effect the transfer, the financial collaboration server system 106 can provide information to each financial institution server system associated with each financial institution identifying the transaction, e.g., respective financial account numbers and routing numbers of the financial institution.

Furthermore, a user can view particular transactions from financial institutions, and provide information, e.g., photos or images, text, audio, and so on, to the financial collaboration server system 106 to associate with particular transactions. The financial collaboration server system 106 can store the received information in the user database 107, e.g., each transaction can be included as a data tuple in a row of a table, and the information can be appended to the data table or a reference to the information can be included. For example, a user can view a particular transaction, e.g., a payment to a restaurant, and attach an image of the bill, e.g., the user can take a photo of the bill at the restaurant with a user device.

The financial collaboration server system 106 can provide financial services, e.g., as described above, to a user on behalf of a financial institution. That is, the financial collaboration server system 106 can white label communications it sends to the user's device 104 with the financial institution's logo, colors, or other information. In this way the user can view the communications on the user device 104, and is given the impression that he/she is interacting with an associated financial institution server 112 rather than the financial collaboration server system 106. The financial collaboration server system 106 can store, e.g., in a database, information associating financial institutions with respective graphic images and color codes. A financial institution can utilize the financial collaboration server system 106 to provide a platform to its users that can interact with a multitude of other financial institutions, e.g., the financial collaboration server system 106 can aggregate financial accounts. Additionally, the financial collaboration server system 106 allows for users of the financial institution the ability to collaborate with other users at the same, or different, financial institution.

As described above, users can interact with the financial collaboration server system 106, either directly or through a financial institution's server system, to manage their financial accounts for various financial institutions. Users can interact with the financial collaboration server system 106 to perform operations related to online banking, electronic bill payment, applying for a loan from a financial institution, and transferring funds between their financial accounts. Users can also interact with the financial collaboration server system 106 to create shared budgets with other users, shared goals with other users, and alerts, as described below. Further, users can interact with the financial collaboration server system 106 to view and categorize financial transactions that were performed with financial institutions.

Users of the financial collaboration server system 106, e.g., users 102 and 103, can be in a financial collaboration group, e.g., roommates responsible for rent, users in a business relationship, friends that desire to share the expense of a particular item or event, members of the same family that desire to pay each other's bills or easily share money, a conservatorship with one or more users acting as guardians and another user acting as the conservatee, one or more users acting informally as guardians with another user, e.g., an elderly person or child.

The financial collaboration server system 106 is configured to generate and store information identifying the financial collaboration groups between users at the request of a user, e.g., user 102. The user 102 can create a financial collaboration group sending a request to create a new group from the user device 104 to the financial collaboration server system 106. The request can include a name for the group.

In addition, either in the request to create the group or in a communication sent thereafter from the user device 104 to the financial collaboration server system 106, the user can identify one or more other users, e.g., user 103, who are to be involved in the financial collaboration group. The financial collaboration server system 106 can send a message to the user device 105 of the user 103 indicating that the user 103 is being invited to the group. The message can include the name of the group and an identification of the user 102 who initiated the invitation. If the user 103 sends a consent message from the user device 105 back to the financial collaboration server system 106, the financial collaboration server system 106 will then update the membership of the financial collaboration group to include both user 102 and user 103.

The financial collaboration server system 106 stores information identifying the financial collaboration group and the membership of the group in the user database 107. For example, for each group, the financial collaboration server system 106 can store an identifier for the financial collaboration group, and the user account identifiers for each user that is a member of financial collaboration group.

Additionally, the user 102 can identify financial information to be shared with other users in the financial collaboration group, e.g., one or more financial transactions from an aggregated financial account, a financial account, an expense, and so on. Similarly, the one or more other users in the financial collaboration group can identify respective financial information that will be involved in the financial collaboration group. The financial collaboration server system 106 stores the identification received from the user of which financial information is to be shared by the user with other users in the financial collaboration group. The financial collaboration server system 106 can also optionally store an identification from the user of a level of access for the other users to the user's financial accounts, e.g., operations that can be performed by the other users on the user's financial information.

After creating the financial collaboration group, financial information can be shared amongst the users in the relationship. For instance, a financial account of a user, e.g., user 102, in the financial collaboration group can be shared with one or more of the remaining users, e.g., user 103. Sharing a financial account means that a user 103 can perform operations on the user's 102 financial accounts. Some examples of operations that can be performed on another user's 102 financial accounts include viewing financial transactions of the other user's 102 shared financial account, providing comments on particular financial transactions of the shared financial account, identifying financial transactions and providing money to the user 102 to reimburse the user 102 for the financial transaction, and transferring money from the user's 102 shared financial account to a financial account of the user 103, e.g., to pay a bill. For instance, a first user 102 can share a financial account with a second user 103. The financial collaboration server system 106 can provide a list of financial transactions to a user device of the second user 103. The second user 103 can then select from among the received financial transactions, and provide a request to the financial collaboration server system 106 to transfer money to user 102 to pay for a portion of the identified financial transaction. Additionally, upon the first user executing a financial transaction, e.g., paying for something with a credit card, the financial collaboration server system 106 can receive information identifying the financial transaction and automatically provide the financial transaction or presentation on the first and second user's user devices.

Additionally, a user can share individual financial transactions of an aggregated financial account with other users in the financial collaboration group. The financial collaboration server system 106 can provide a list of all transactions from a user's aggregated financial accounts, and the user can select from among the financial transactions. The selected financial transactions can then be provided for presentation on each user device of the users in the financial collaboration group. The financial transactions can be provided with a request for reimbursement. In some implementations the financial collaboration server system 106 can determine an amount of money owed by each user in the financial collaboration group. In some implementations a user that shares one or more financial transactions can enter or identify an amount of money owed by each user.

Furthermore, users in a financial collaboration group can enter text, audio, images, or documents, and have it provided for presentation on user devices of other users in the financial collaboration group. A chat interface, e.g., a window configured to receive text entered by a user, provide the text to the financial collaboration server system 106, and display text received from financial collaboration server system 106, can be provided on each user's user device.

A user can specify the types of operations that other users are authorized to perform in the context of the financial collaboration group. For example, a user can specify that another user, e.g., a financial advisor, is restricted to viewing and commenting on the user's financial transactions.

In some implementations, to specify the types of operations that a user can perform in the context of the financial collaboration group, a relationship category can be selected by a user when requesting a financial collaboration group. Examples of relationship categories include an inner circle, e.g., with full authorization to monitor another user's transactions, transfer money, and so on, friends, family, or advisors, e.g., with a limited ability to comment on another user's transactions, and view financial information of the other user authorized by the other user.

In some implementations the financial collaboration server system 106 can determine a relationship category from information identifying users to be added to the financial collaboration group. The financial collaboration server system 106 can obtain information from a social network, a contacts list on a user device, and so on, that identifies a relationship between two or more users. From this relationship the financial collaboration server system 106 can obtain information identifying a likely relationship category, and provide it for presentation on a user device. A user can then select the relationship category, or choose another one.

A user 102 in a financial collaboration group can request that the financial collaboration server system 106 generate a financial goal, e.g., a budget, and provide it to each user device of a user in the relationship. The user 102 can provide, with the request, information identifying a particular goal, e.g., a cap of an amount of money to spend by all users, or by particular users, one or more dates associated with the budget, specific types of transactions, e.g., restaurant, home improvement, and associated caps of money, and so on. The financial collaboration server system 106 can provide information for presentation on each user device of users in the financial collaboration group, and update the information upon a user action, e.g., a user selecting a ‘refresh’ button on the user device that obtains new information from financial institution server systems, by polling associated financial institution server systems for new financial information, or by receiving financial information from financial institution server systems as a push.

Additionally, the user 102 can request that the financial collaboration server system 106 provide the users in the financial collaboration group with alerts upon specific actions occurring. The alerts can be provided to the user devices, or can be provided to respective e-mail addresses associated with the users, or as a text message to respective mobile phone numbers associated with the users. The financial collaboration server system 106 can obtain the e-mail addresses and phone numbers from customer data, described above, or from information previously provided from the user, e.g., during a user account sign up process with the financial collaboration server system 106. For instance, the financial collaboration server system 106 can receive information from a financial institution identifying an upcoming bill is due. The financial collaboration server system 106 can provide an alert to the users identifying the bill.

The financial collaboration server system 106 can also generate financial goals and alerts for particular users in the financial collaboration group. That is, a user 102 can set a personal alert for their own financial accounts, or set a personal budget for their own financial accounts, or for financial transactions in a particular the financial collaboration group.

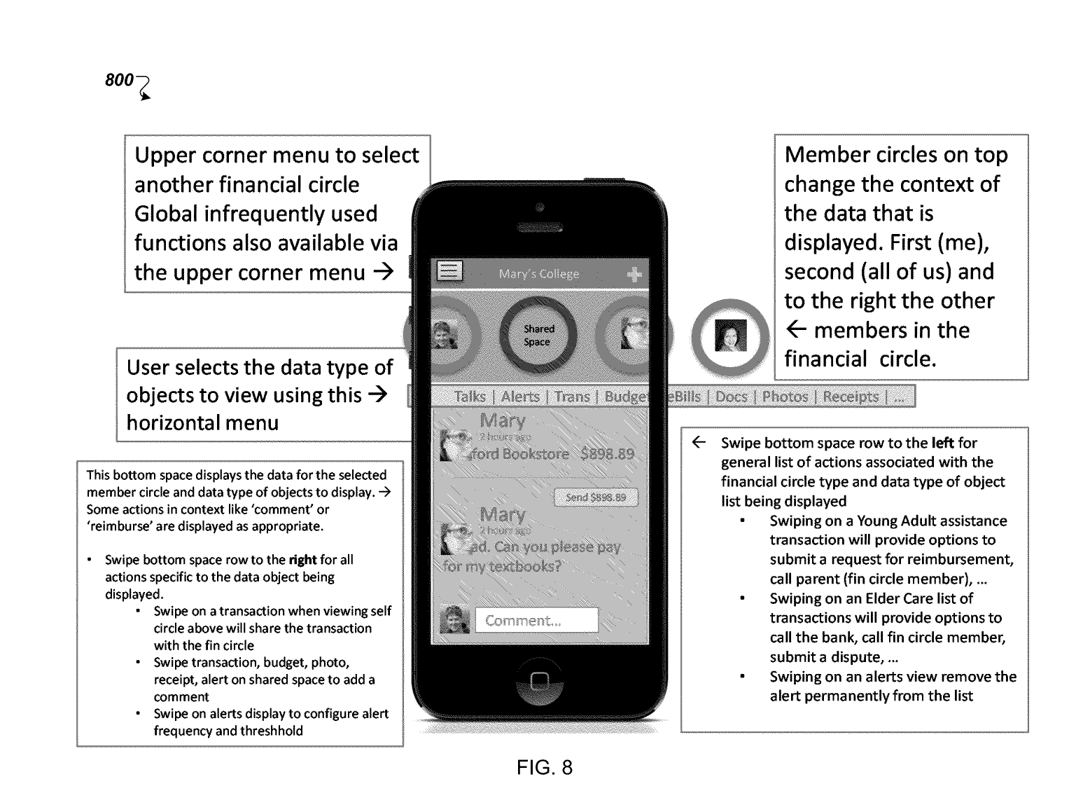

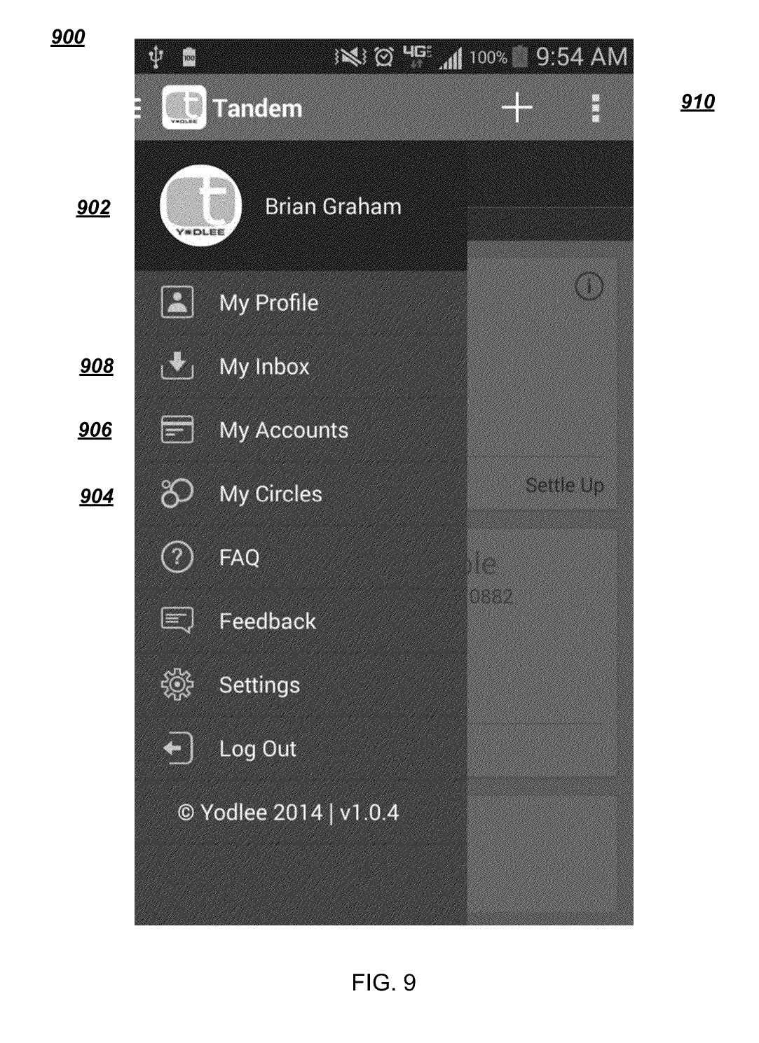

In some implementations, financial collaboration groups can be implicit, and users of the financial collaboration server system 106 do not need to provide a request to create a financial collaboration group. A user can identify to the financial collaboration server system 106 one or more other users to share a financial transaction or financial account. For instance, three users can eat lunch together, and two users can transfer an amount of money to the paying user. In another instance, three users can eat lunch together, and the paying user can identify the two other users who then receive, from the financial collaboration server system 106, a request to transfer money to the paying user, e.g., a request for reimbursement described below with reference to FIGS. 9-15.

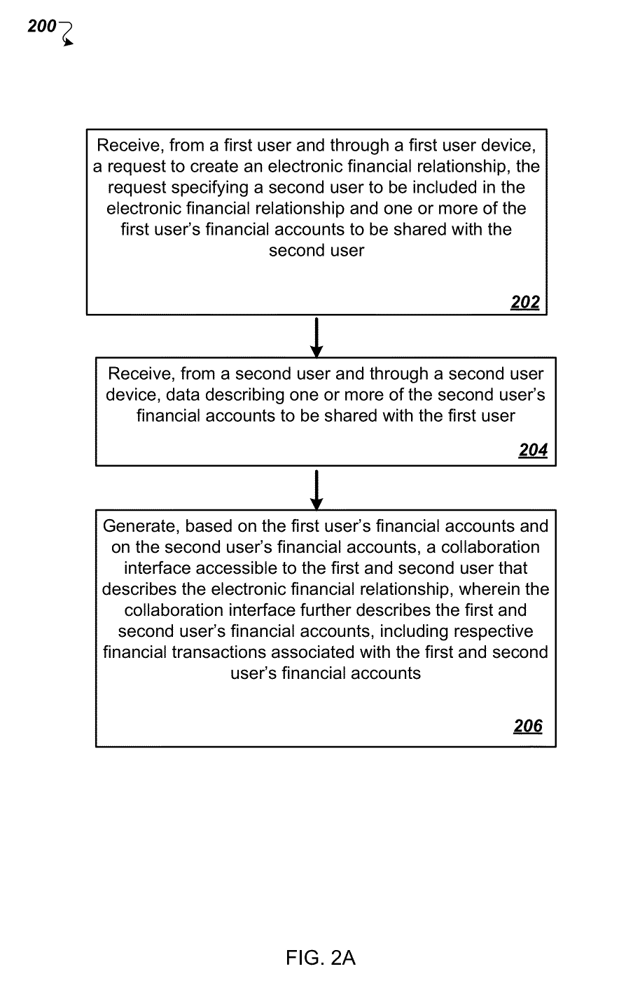

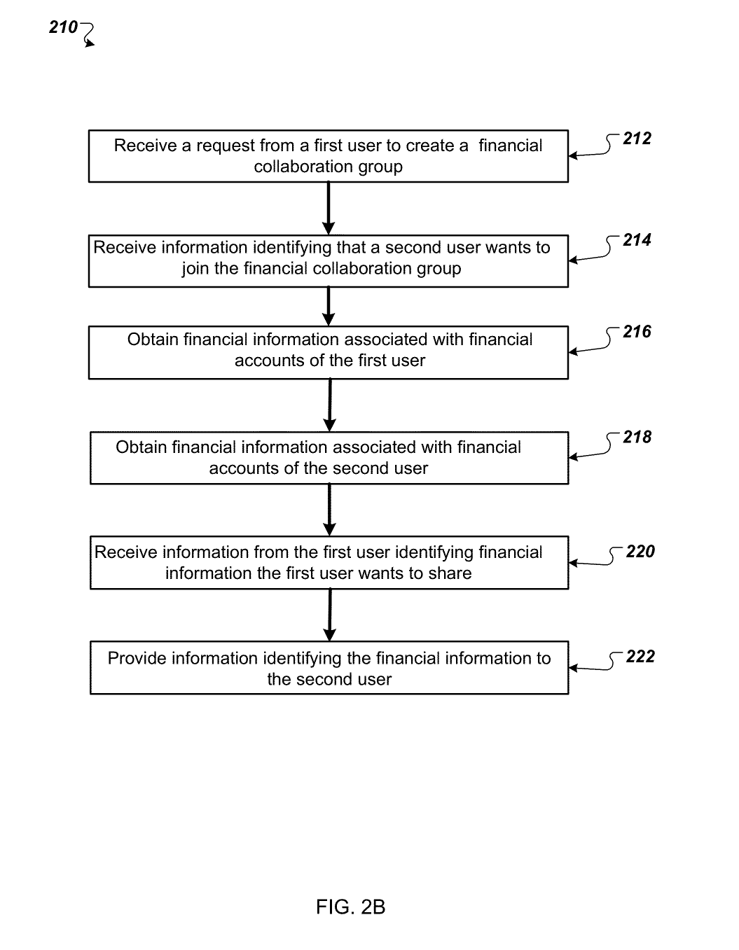

FIG. 2A illustrates a first example method 200 for collaborative financial planning. For convenience, the example method 200 will be described in reference to a system that performs the method 200. The system can be, for example, the financial collaboration server system 106.

The system receives a request to create a financial collaboration group from a first user (step 202). As described above, the request can be received, for example, from a first user operating a user device in communication with the system. The request can specify one or more different users to be included in the financial collaboration group and one or more of the first user's financial accounts to be shared with the different users. Additionally, the request can include information entered by the first user, including text describing the financial collaboration group, e.g., the purpose of the relationship, audio recordings, e.g., a verbal description, video, images, and so on. This information can be presented to the other users specified in the request.

The system receives an identification of a user to include in the financial collaboration group, e.g., the first user can type a name into a user device and the system can determine a user identifier stored in the system that corresponds to that name. If the system determines more than one name, the system can provide a list of names for presentation on the user device. Additionally, the system can provide a subset of the most likely user's that have the requested name, e.g., the top 5, 10, and so on. To determine the most likely users, the system can look at information stored in the system associated with each determined user, e.g., location of the user, whether the user is in a financial collaboration group with another user that is in a separate financial collaboration group with the first user. From this information the system can determine the most probable users, and provide information describing each user to the first user. The first user can then select from among the list.

Additionally, the system can receive an identification of a user to include in the financial collaboration group from a contact list of the first user, e.g., on the user device, or from a contacts list of a social network the user belongs to. The user can select a contact from the contacts list, and provide information identifying the contact to the system. Upon receiving the information, the system can determine a user that corresponds to the contact. For instance, the contacts list can contain metadata describing each contact, e.g., a name, a telephone number, an e-mail address, and so on. The system can obtain this metadata and compare it to users associated with the system.

In some implementations, when providing a request to create a financial collaboration group, a user specifies a relationship category, e.g., inner circle, friends, family, or financial advisors, for the financial collaboration group. Each relationship category restricts the operations that users in a financial collaboration group can perform, e.g., operations on other user's financial information. Upon receipt of a selection of a relationship category, the system can obtain information identifying allowable operations. Examples of operations available to the first user on another user's financial information in a particular relationship category are shown in Table 1.

TABLE 1
Relationship categories and Operations available

| | Controlling | Viewing all | Viewing |
|---|---|---|---|
| | financial | transactions in | individual |
| | account of | another user's | transactions |
| | another user | financial account | shared by a user |
| Inner Circle | X | X | X |
| Advisor | | X | X |
| Friend | | | X |

Table 1 describes operations available to users in a relationship category, e.g., operations on another users financial information. The table describes three relationship categories, Inner Circle, Advisor, and Friend, and three example operations available to users in the relationship categories.

The example operations include controlling a financial account of another user that has shared the financial account with the other users in the relationship category. For instance, the first user can identify to the system that the relationship category should be “inner circle,” and also a financial account to be shared with the users in the relationship category. Another user in the relationship category can then transfer money to the financial account shared with the users, and also transfer money out of the shared financial account. The system can restrict transferring money out of a shared financial account to pay for expenses incurred by the other user that are to be shared by the first user. Additionally, the system can provide a notice for presentation on the first user's user device identifying that the other user is transferring money. The system can wait for the first user to approve the transfer before providing information to the financial institution of the financial account identifying the transfer.

Other example operations include viewing financial transactions in a shared financial account. For instance, the first user can identify to the system that other users in a financial collaboration group are allowed to view financial transactions in a shared financial account of the first user. Similarly, the first user can identify that only financial transactions specifically shared by the first user are to be presented to other users in the financial collaboration group.

In some implementations, the system provides default relationship categories to the first user, e.g., inner circle, friends, family, or advisors, that are each associated with allowable operations. In some implementations, the system provides “inner circle,” “friends,” “family,” and “advisors,” as default relationship categories. Users can also create custom relationship categories, and specify allowable operations.

The system can also determine a relationship category upon receipt of a user to add to the financial collaboration group. As discussed above, the system can identify contacts of the first user. The system can obtain metadata from the contacts list, e.g., contacts list in a social network that identifies a relationship between the first user and the user to add. The system uses this relationship to determine a relationship category. For example, if the contact and the user are family, the relationship category can be family. If there is more than one potential relationship category, the system can provide the relationship categories to the first user for selection.

In some implementations, upon receiving a request to generate a financial collaboration group, the system determines a relationship category by providing questions to a user. For example, the system can provide questions such as, e.g., “are you going on a trip with friends?”, “do you want to monitor a family members finances?”, “do you want to apply for a loan?”, “do you want an advisor to help with finances?”, “do you want to split bills with a roommate?”, “do you want to split finances with family members?”, and so on. The questions can be provided for presentation on the user device, and the system can receive a selection from the first user to use in determining a relationship category. For example, if the user affirmatively answers “do you want to apply for a loan?” the system can determine that the relationship category is one of “advisor.”

The system receives, from a second user and through a second user device, data describing one or more of the second user's financial accounts to be shared with the first user (step 204). As described above, the request can be received, for example, from a user operating a user device that is interacting with the system.

The system provides information to the second user identifying that the first user wants to include the second user a financial collaboration group. The information can include the relationship category, any other users in the financial collaboration group, and any user entered information, e.g., text, audio, video, images, that the first user has input. In some implementations the information can be presented on the second user device in an application executing on the second user device. The application can present a window in the application identifying the information, and include an option to select whether the second user wants to be in the financial collaboration group. In some implementations the information can be presented on the second user device in a website, e.g., a resource or document, displayed in a web browser executing on the second user device.

The system receives information from the second user device identifying that the second user wants to be in a financial collaboration group. The second user can specify one or more financial accounts, e.g., a checking account, savings account, credit card account, to share with the first user. If one or more financial accounts are specified, the system receives information identifying the financial accounts, e.g., identifiers of the financial accounts stored in the system, names of the financial accounts, financial account numbers, and so on. The system can access the second user's account stored by the system, and include a reference to the financial collaboration group.

The system generates, based on the first user's financial accounts and on the second user's financial accounts, information to present in a collaboration interface on the first and second user's user devices that describe the financial collaboration group (step 206). The collaboration interface is a user interface presented on the first and second user's respective devices; examples of the collaboration interfaces is illustrated below, with reference to FIGS. 4-15. The collaboration interface can include user representations, e.g., a picture, a user selected image, a name, of all users in the financial collaboration group.

The collaboration interface can include one or more financial transactions from a financial account shared with the financial collaboration group. For instance, the financial transactions displayed in the collaboration interface can be transactions selected by a user from a list of financial transactions they have made. For instance, the second user can provide a financial transaction related to a textbook payment to be displayed in the collaboration interface, allowing the first user to see it. The system can receive a selection of a financial transaction from the second user, and provide information identifying the financial transaction for presentation on the first user's user device.

Additionally, the system can identify financial transactions, e.g., financial transactions made after the start of the financial collaboration group, or financial transactions made prior to the start, that relate to relationship category. For example, the second user can be a student, and the first user can be a parent in a financial collaboration group related to paying school expenses incurred by the second user. The system can scan through financial transactions incurred by the second user and identify financial transactions associated with a name of the school, or associated with transactions that might be related to school. In some implementations the system can classify financial transactions according to subjects, e.g., school, business, food, by determining the nature of the entity, e.g., business, that received money in the financial transaction.

Furthermore, the collaboration interface can include a chat interface to display comments from the first user or the second user. The chat interface can be provided for presentation in the collaboration interface to allow users to provide comments related to the financial collaboration group. The chat interface can also be specific to one or more financial transactions, allowing users to also comment on specific transactions.

The collaboration interface includes one or more context options, e.g., options that when selected provide specific functionality or information related to financial collaboration group. For instance, a context option can be a reminder, and a user can select the context option to generate an arbitrary reminder. Another context option can be to generate a budget, receive documents, images, or audio, by a user.

Context options can also provide information related to a subset of the users in the financial collaboration group, e.g., the first user can select a context option identifying that only information related to the second user is to be displayed, and not any other users. Upon selecting a context option identifying a subset of the users, the system can provide only financial transactions that involve the subset of the users. Additionally, the system can provide only comments made by the subset of the users.

Once the financial collaboration group is created, the first and second users can interact with each other through the generated interface to collaborate on their personal finances, e.g., viewing and commenting on financial transactions, managing shared budgets, managing shared goals, collecting reimbursements, or splitting shared expenses, as described above.

The first user and second user can evaluate shared financial transactions for purposes of expense analysis, for example, by interacting with the system to generate charts, e.g., pie charts or graphs, based on information in the shared financial transactions. The system can provide, for example, expense analysis tools that display, for a user's financial accounts, the sum of all the financial transactions in the financial accounts for each category as one slide in a chart, e.g., a pie chart, or graph, e.g., donut graph. In some implementations, the system is configured to evaluate shared financial transactions to provide system-generated advice. For example, the system can determine that the first user is paying too much for a certain transaction, e.g., car insurance and can offer alternatives that can help the user save money, e.g., rates for alternative car insurance companies. To effect this determination, the system can obtain information identifying average rates of specific classes of transactions, e.g., car insurance, home insurance, gym memberships, and so on. The system can then identify transactions that are in one of the specific classes of transactions, e.g., by providing a business name to a search engine and identifying a class, or by storing a list of corporations and specific classes they are a member of, and determine the amount of money paid to the business in the transaction. By comparing the average rate to the amount in the transaction, the system can determine whether the amount is high. Upon determining the amount is too high, the system can obtain rates from other companies. In some implementations the system can have rates from companies provided to the system by the companies, e.g., as advertisements.

Furthermore, the first user or second user can interact with the system to configure custom alerts that are triggered when a certain condition is satisfied, e.g., upon detecting a high transaction amount or a low financial account balance. The first user or second user can also configure shared reminders for users in the financial collaboration group, e.g., reminders to pay bills. Custom alerts and reminders, when triggered, can be communicated from the system to user devices belonging to users in the financial collaboration group. After receiving custom alerts or reminders, users can interact with their respective user devices to tag or comment on financial transactions that are related to the alert or reminder.

One example financial collaboration group is directed to applying for a loan from a financial institution, such as a bank or lending group. The resulting financial collaboration group is between the first user and the second user, e.g., an employee of the financial institution. The first user can allow access to his/her financial account information, and permit defined operations to be performed on it, e.g., viewing financial transactions, viewing payment history to creditors, viewing the line of credit available to the user, cash flow available, and collateral available to secure the loan. In some implementations the first user can specify less than the full amount of financial accounts they have with financial institutions to share with the loaning financial institution.

Another example financial collaboration group is directed to managing shared personal finances. This type of financial collaboration group is between at least the first user and the second user, e.g., between couples, spouses, families, roommates, or business partners. Each user in the financial collaboration group can share their respective financial transactions, or financial accounts, with the other users. The users can opt to share all of their financial transactions in their respective financial accounts, all transactions of individually specified financial accounts, or they can share specified individual financial transactions. In some implementations, financial transactions can be categorized, either by the user or automatically by the system, and the user can identify categories of financial transactions that are to be shared with other users in the financial collaboration group. Furthermore, privacy protections can be identified by a user, which automatically identifies to the system not to share specific types of financial transactions with other users, or financial transactions involving specific businesses or types of businesses.

Additionally, the first user and second user can interact with the system to define and collaborate on shared budgets, e.g., rent, utilities, restaurant dining, groceries, etc. In some implementations, when creating a shared budget, the first user or second user specifies a budget name, the categories of financial transactions to be included in the budget, a budget timeframe, e.g., daily, weekly, monthly, yearly, or a custom timeframe, a threshold budget amount, and one or more actions to be performed by the system when the financial transactions exceed the threshold budget amount.

For example, the first user can define a shared grocery budget that includes financial transactions categorized, either by the first user or by the system, as financial transactions relating to groceries, a monthly budget timeframe, threshold budget amount of $400, and a shared alert that is generated when the financial transactions exceed the threshold budget amount. In this example, the system will evaluate the aggregate of the ongoing financial transactions of the first user and the second user that are categorized as groceries to determine whether the threshold budget amount has been exceeded for the month. Upon a positive determination, the system can generate a shared alert that is communicated to the user devices of the first user and the second user.

In some implementations, the system can evaluate a budget with respect to financial transactions that relate to the budget and the budget timeframe to determine budget utilization. For example, the system can determine, for a monthly restaurant dining budget, a utilization of the budget.

In some implementations, to determine the utilization of a monthly restaurant dining budget, the system can divide the amount of money spent on restaurants in the month so far, by the total budget for restaurants multiplied by the fraction of the elapsed time in the month and the total time in the month. The system can communicate the budget utilization to users in the financial collaboration group so appropriate action, if any, can be taken by the users. For example, the system can notify the first user and the second user that only 20 percent of their monthly restaurant dining budget has been utilized and that half of the month has passed. That is, if the budget is $400 a month, and the first user and the second user have only spent $80 by the middle of the month, then the system computes:

$$40 \% -= \frac{\text{?}}{400 \text{?} ( \frac{\text{?}}{\text{?}} )}$$

$$\text{?} \text{indicates text missing or illegible when filed}$$

The number 40% identifies to the first and second user that they have only utilized 40% of an expected amount of money for restaurants at that point. The system can identify that the first and second user could have spent $120 more by that point in time, e.g., the system can identify that the first and second user have spent 40% of an amount of money allowable to be spent by the middle of the month. After being notified that they are under budget, the users in the financial collaboration group can, for example, dine out at a nice restaurant.

In some other implementations, to determine the utilization of a monthly restaurant dining budget, the system can determine the percent of budget left that should be spent on restaurants. For example, if the budget is $400 a month, and the first and second user have spent $80 by the middle of the month, the system provides information to the first user and second user identifying that they have utilized 20% of the total budget for the month.

The first user and second user can also interact with the system to define a shared goal. In some implementations, when creating a shared goal, a user specifies a goal name and a goal amount. Each user in the financial collaboration group can also specify the amount of funds they will contribute toward the shared goal. Furthermore, the users can specify respective financial accounts from which the funds are to be transferred from and also a time interval for how often funds should be transferred, e.g., once, daily, weekly, monthly, yearly. The funds can be provided to a financial account specified by the first user or second user. For instance, the funds can be provided to a savings account shared by the first user or second user, or to a joint financial account of the first user and second user.

For example, the first user can define a shared long-term goal with the second user, e.g., spouse, for saving toward a down payment for a house. The first user can interact with the system to specify a goal amount, e.g., of $100,000, and a contribution, e.g., of $2,500 to be deducted from the first user's checking account every month. The second user can optionally interact with the system to specify a contribution, e.g., of $2,000 to be deducted from the second user's savings account every month. In response, the system can display progress of the shared long-term goal, for example, in a graphical user interface. The system can also communicate alerts to the first and second users, for example, through their respective user devices, to provide status updates for the shared long-term goal. Shared goals need not be limited to long-term goals and can involve short-term objectives, e.g., purchasing a television as well.

In some implementations, the system automatically deducts, from each user's financial account, a user's respective contribution toward the shared long-term goal at the specified time interval. For example, the system can transfer, every month, from the first user's checking account, a contribution amount of $2,500 to a different financial account, depending on the first user's preference. Similarly, the system can transfer, every month, from the second user's savings account, a contribution amount of $2,000 to the different financial account. The system can provide to the first and second user, e.g., through the collaboration interface, a status of their shared long-term goal, the amount of funds contributed thus far, an amount of funds needed to reach the shared long-term goal, an estimated time for reaching the shared long-term goal, and respective amounts that each user has contributed toward the shared long-term goal, to name a few examples.

In some situations, the first user and second user can identify a shared goal that does not have a goal amount that needs to be satisfied. For example, parents and grandparents may have a shared goal of contributing to a child's college education. Thus, in some implementations, when creating a shared goal, a user specifies a goal name and identifies other users that will be involved in contributing to the shared goal. Similarly, each user in the financial collaboration group can specify the amount of funds they will contribute toward the shared goal, respective financial accounts from which the funds are to be contributed, and a time interval for how often funds should be contributed.

The first user and second user can also interact with the system to manage shared expenses. For example, the first user can create a financial collaboration group with the second user, e.g., a roommate of the first user, to collaborate on shared expenses, e.g., rent, utility bills, and shared grocery bills. The roommates can communicate with each other with respect to specific financial transactions shared by one of the roommates with the other users in the financial collaboration group. For example, the first user can receive information identifying a bill from the system, and select the bill to be shared by the system on the remaining user's user devices. The first user can then initiate an electronic message conversation, e.g., post a comment about the financial transaction, or type into a chat window, with other roommates regarding the bill and can request that the bill be split among the roommates. In response to user input, the system can split the shared bill among the roommates and each roommate can then interact with the system to authorize a respective payment for their portion of the bill. The system can determine when all roommates have authorized a payment for their portion of the bill, and then transfer the full bill payment to the company owed money. Additionally, the first user can pay the entirety of the bill, and request that the roommates transfer money to the first user.

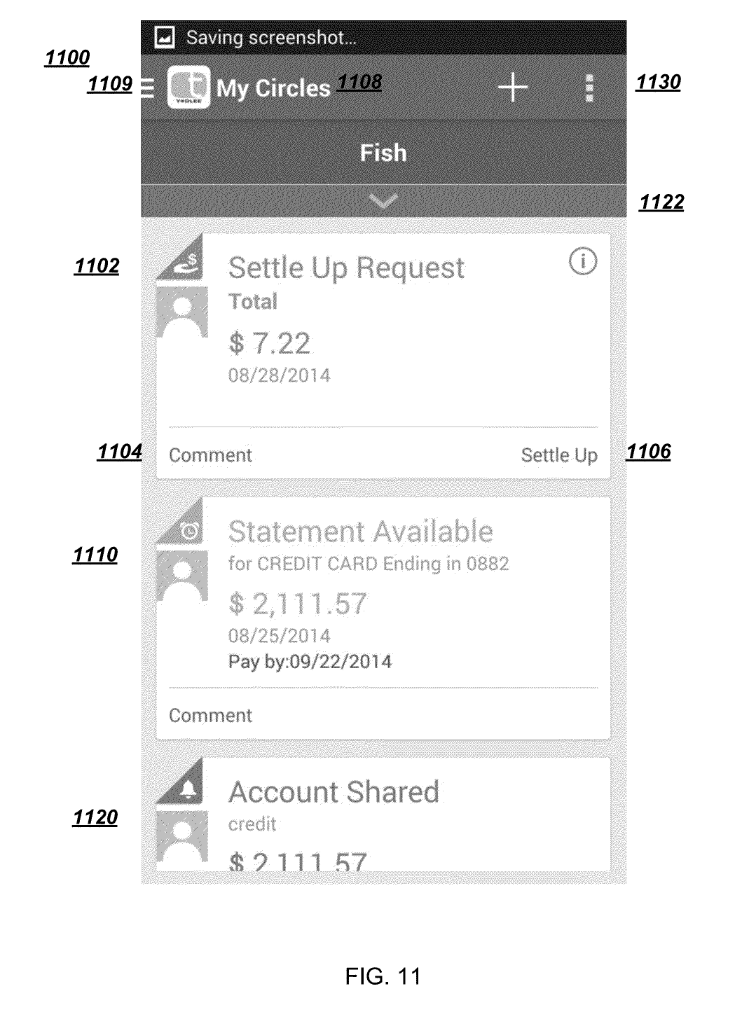

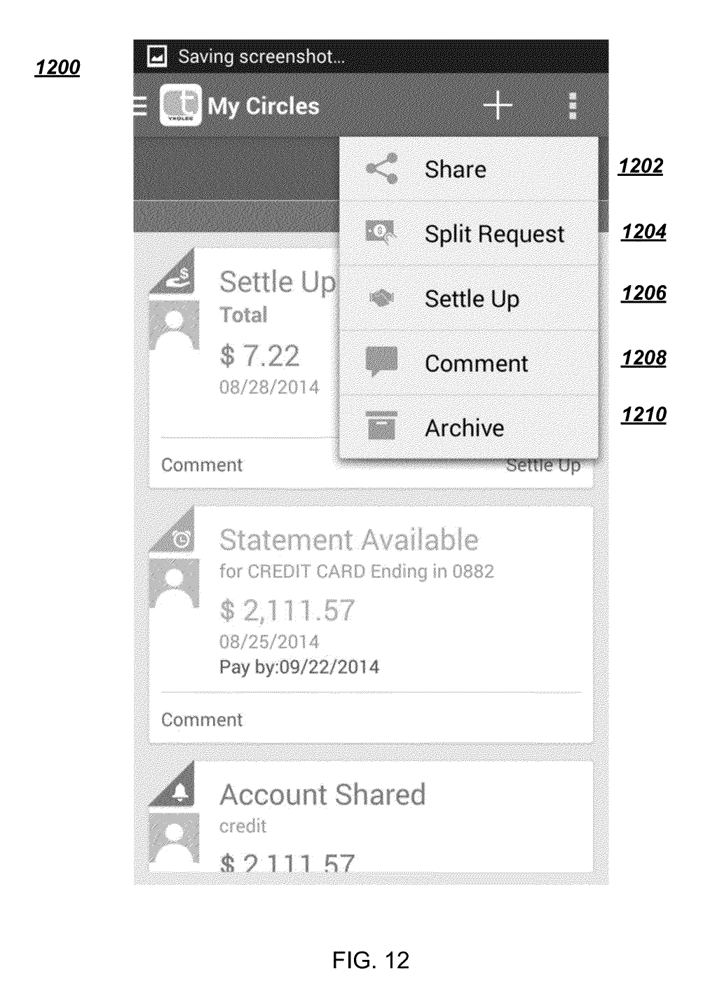

Similarly, the first user and second user can create a short-term financial collaboration group for the purposes of managing event-based expenses. For example, the first user and second user can go on a road trip and create a financial collaboration group for collaborating on shared expenses incurred on the road trip. The first and second user can interact with the system to share financial transactions from their respective financial accounts that are related to the road trip. In some implementations the first user and second user can identify specific financial transactions to the system, and the system can provide them for presentation on the remaining user's user devices. In some implementations the system can automatically identify financial transactions incurred on the road trip, e.g., the system can include any financial transaction from a city outside of each user's normal location, the system can include any financial transactions incurred after the first user and second user create the financial collaboration group, and so on. The users can then interact with the system to request reimbursement or a splitting of the expenses from the other users in the financial collaboration group. Requesting a reimbursement using an example collaboration interface is described below, with reference to FIG. 11-12.

The techniques described above can be used to support other types of financial collaboration groups. For example, the first user user can create a financial collaboration group with the second user, e.g., a financial advisor. The first user can share their financial accounts with the financial advisor and can limit the second user to viewing the first user's financial transactions. The financial advisor can evaluate the first user's financial transactions to provide financial advice.

The financial advice from the advisor can be provided in the interface in the context of investment transactions. For example, goals for users in the financial collaboration group, e.g., the estate or family, can be established by the financial advisor as part of the engagement proposal inside the collaboration interface. Alerts can be setup to track progress towards the growth goals. The financial advisor can also setup alerts to monitor financial accounts, e.g., an alert to monitor for high balances on low interest bearing financial accounts, low balances on financial accounts used for funding monthly bills, or high debts, e.g., credit card debts, with high APR.

The collaboration interface can provide other types of information for financial collaboration groups. For example, the interface can provide a net worth for a financial collaboration group, a portfolio manager for a financial collaboration group, a retirement calculator for a couple using the aggregate of their financial collaboration group, debt reduction planning based on the aggregate of a couple's financial collaboration group, and tax planning advice for a financial collaboration group.

The first user can be a parent and the second user can be a child, e.g., a child attending college. The parent can interact with the system to view the child's financial transactions to provide financial guidance. Furthermore, the parent and child can interact with one another through the system to help pay for the child's expenses. For example, the child can interact with the system to upload a bill for course books and can request that the parent pay for the books in full or in part. The parent can interact with the system to view the bill and can instruct the system to authorize payment of the bill, in full or in part, using their respective financial accounts.

In another example, the first user, e.g., an adult child, can create a financial collaboration group with the second user, e.g., a parent in a retirement home or a very elderly parent. The child can interact with the system to view the parent's financial transactions to make sure the parent's finances are safe. Furthermore the child can take control of the parent's financial accounts and pay for bills or financial transactions with the parent's financial account. For example, if the parent's identity gets stolen, the child can view the financial transactions to see if the financial transactions seem logical. Additionally, the child can ensure that the parent does not get taken advantage of by scammers, e.g. people fraudulently obtaining money from the parent. The child can instruct the system to submit a dispute about a particular transaction, alert the bank to potential fraudulent behavior, call the bank about a transaction, or call another member of the financial relationship about a transaction.

FIG. 2B illustrates a second example method for collaborative financial planning. For convenience, the example method 210 will be described in reference to a system that performs the method 210. The system can be, for example, the financial collaboration server system 106.

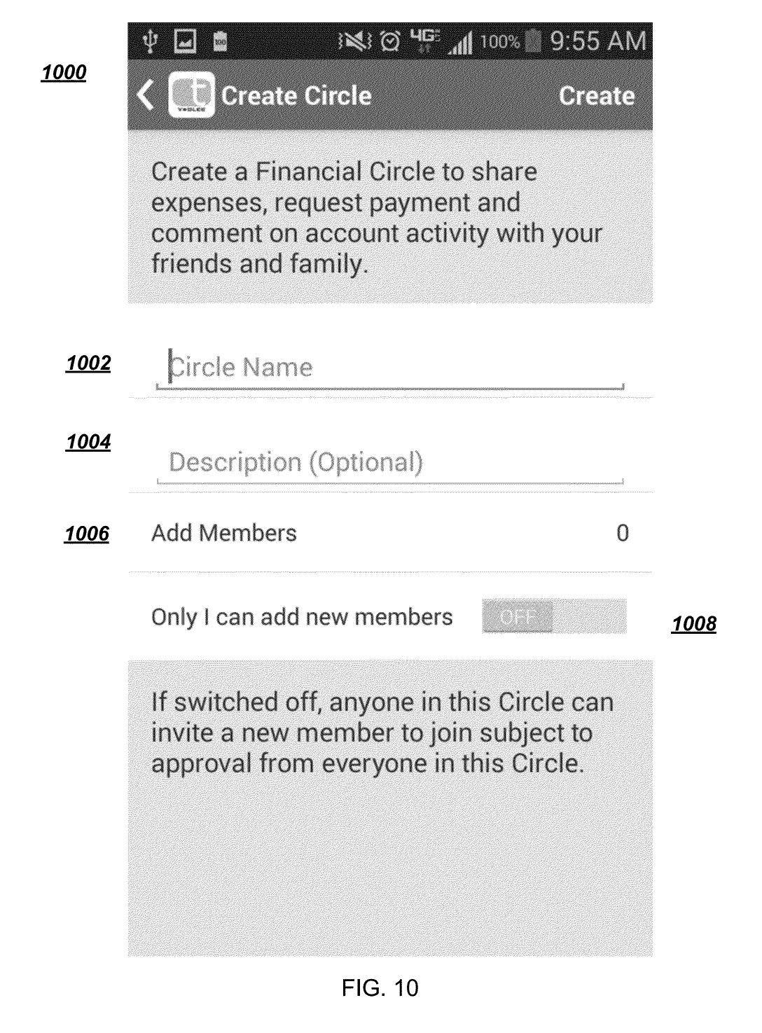

The system receives a request from a first user to create a financial collaboration group (step 212). The first user can execute an application on a user device, e.g., a mobile device, a hybrid, a wearable device, that is in communication with the system, e.g., over the Internet, and provides a user interface for the user to interact with. The first user can select an option in the application identifying that he/she wants to create a financial collaboration group, e.g., the user can select an option in the user interface of the user device and receive interface 1000, described below in FIG. 10.

The request includes a name of the financial collaboration group, and can include a name of a second user. Identifying a name of the second user is described above, with reference to FIG. 2A.

The system receives the request and generates information identifying the financial collaboration group. For instance, the system can store information identifying a user identifier of the first user, a name of the financial collaboration group, a description of the financial collaboration group, and a user identifier of the second user.

The system receives information identifying that a second user wants to join the financial collaboration group (step 214). The system provides information for presentation on a user device of the second user identifying that the first user wants him/her to join a financial collaboration group. The information can identify a name of the first user, and a description of the financial collaboration group, described further with respect to FIG. 2 A.

The second user can then provide information identifying that he/she wishes to join the financial collaboration group. For instance, the second user can select an object to join the financial collaboration group. The user device of the second user then provides information identifying the acceptance to the system.

The system identifies financial information associated with financial accounts of the first user (step 216).

In some implementations the system can store financial information of the first user, e.g., after receiving a request to aggregate one or more financial accounts of the first user. After receiving the request, the system can obtain financial information, e.g., recent financial information, from the financial institutions, and store the financial information with a user account of the first user.

After the first user creates a financial collaboration group, the system can identify financial information associated with the first user. The system identifies financial information associated with zero or more financial accounts of the second user (step 218). The second user can have previously provided a request to the system to aggregate financial accounts. The system can identify the financial information stored in a user account of the second user.

In some implementations, the system does not need to identify, or have stored, financial information of the second user. For example, the first user can be an elderly parent, and the second user can be a child monitoring the elderly parent's finances. In the example, the system would only need to identify financial information of the first user, so that the second user can monitor it, e.g., view financial transactions.

The system receives information from the first user identifying financial information the first user wants to share (step 220). The first user can select financial information to be shared with the second user.

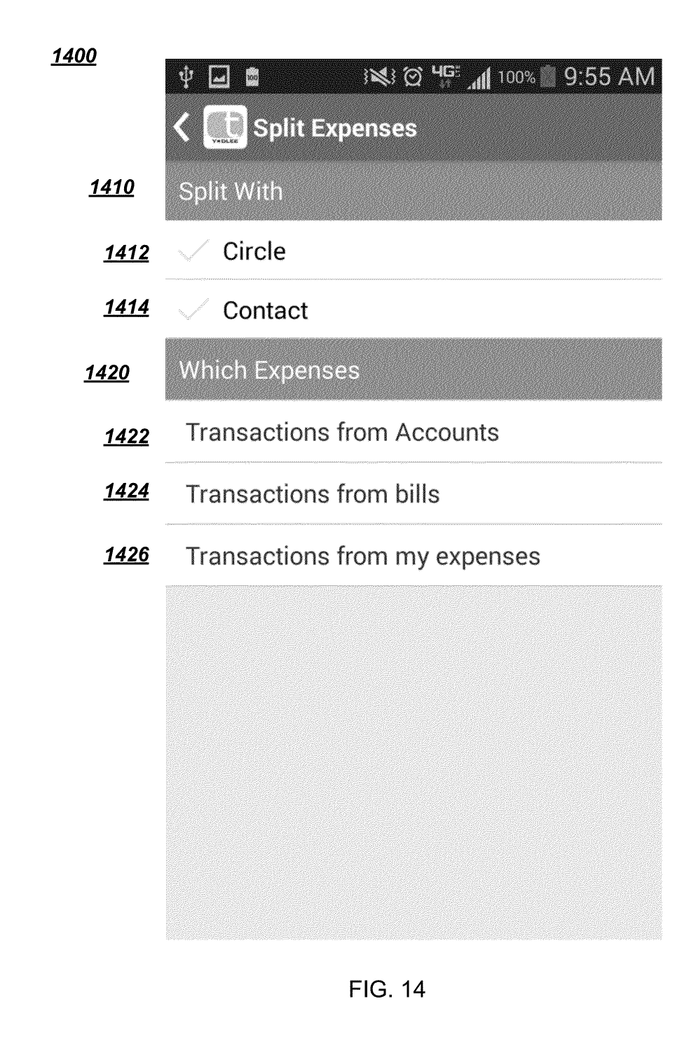

For instance, the first user can identify one or more financial transactions in the identified financial information to be shared with the second user. Identifying the sharing of a financial transaction is described below, with reference to FIG. 14. The system can provide a list of financial transactions for presentation on the first user's user device, and receive a selection of one or more financial transactions. The system can then store information identifying the selected financial transactions, e.g., financial transaction identifiers, payor/payee information, and so on.

The first user can also identify an upcoming financial transaction, e.g., a bill payment that is due soon. The system can obtain upcoming financial transactions from respective financial institutions. The first user can then view the upcoming financial transaction, and select it for presentation on the second user's user device.

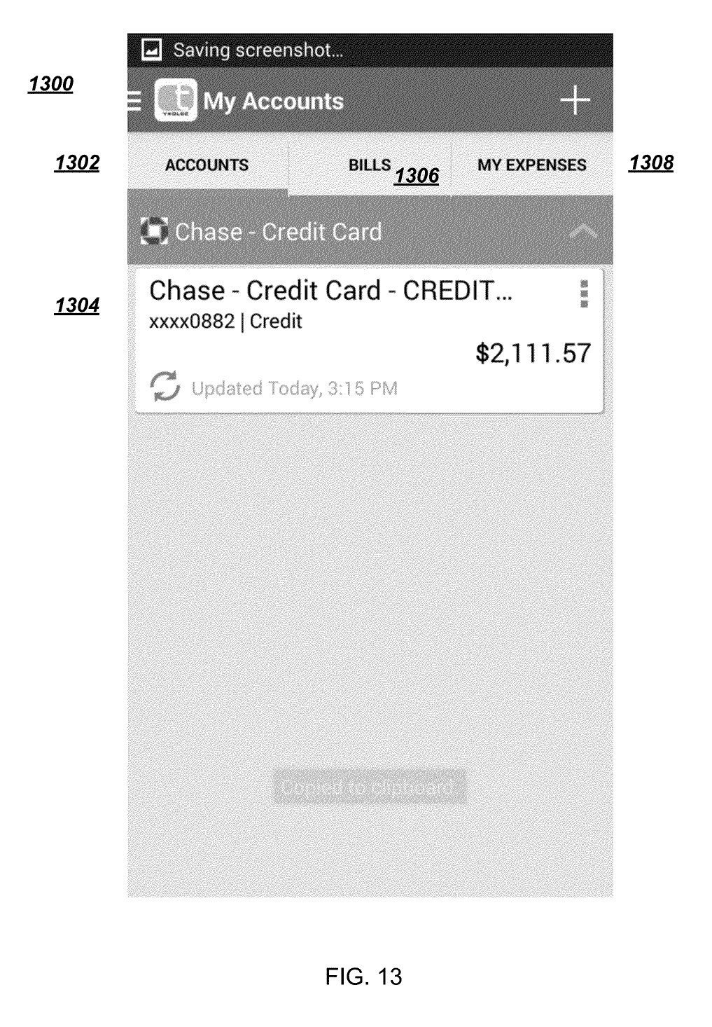

Additionally, the first user can identify that he/she wants to share one or more financial accounts with the second user. Sharing a financial account allows for the second user to perform one or more operations on the financial account shared by the first user. As described above, the operations can include the system providing financial transactions of the financial account for presentation on the second user's user device. Additionally, the second user can identify that he/she wants to remove money from the financial account, or transfer money into the financial account. Identifying the sharing of a financial account is described below, with reference to FIG. 13. The system can store information identifying the selected financial accounts, e.g., a financial account identifiers.

The system provides information identifying the financial information to the second user (step 222). The system provides information identifying financial transactions, or financial accounts, for presentation on the second user's user device. The system can then receive information identifying functions to be performed by the second user.

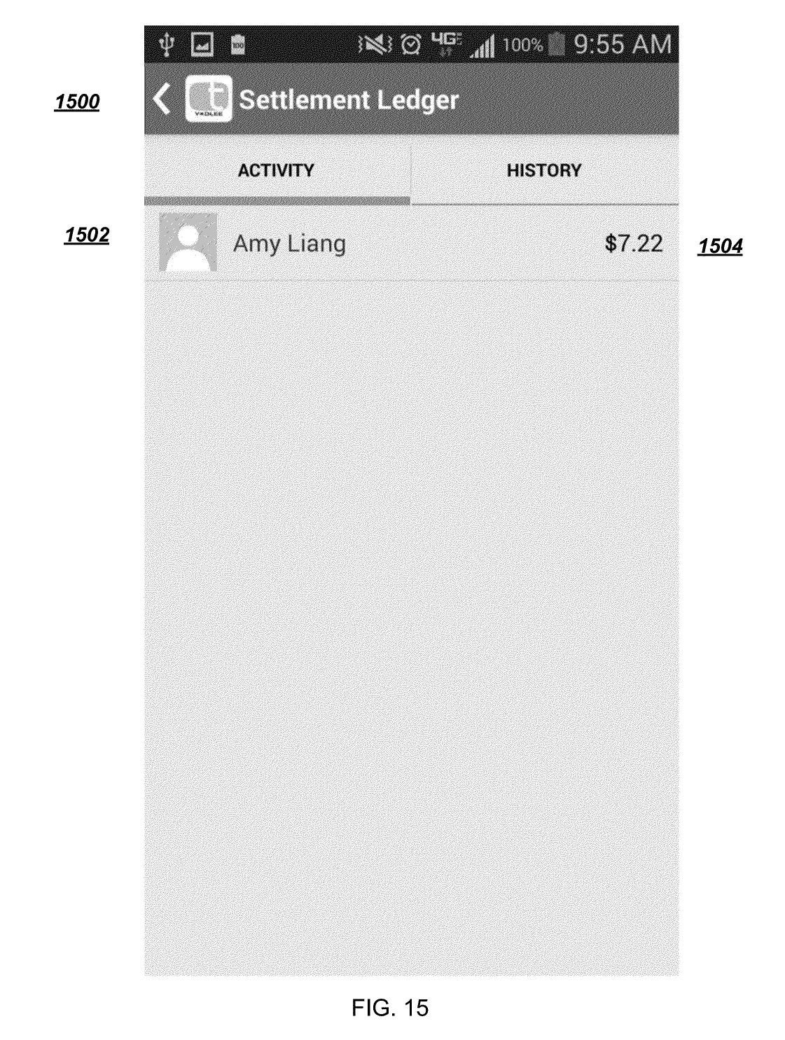

For instance, the second user can identify that he/she wishes to pay for part of a financial transaction, described below with reference to FIG. 15. Additionally, the second user can provide a comment to the system, which the system provides for presentation on the first and second user's user devices, e.g., a comment related to the financial transaction, a comment related to an upcoming bill.

The method described in FIG. 2B can effect the examples of financial collaboration groups described in FIG. 2A. For instance, the first and second user can be roommates, and the first user can provide financial information to the second user identifying a bill, or an upcoming bill.

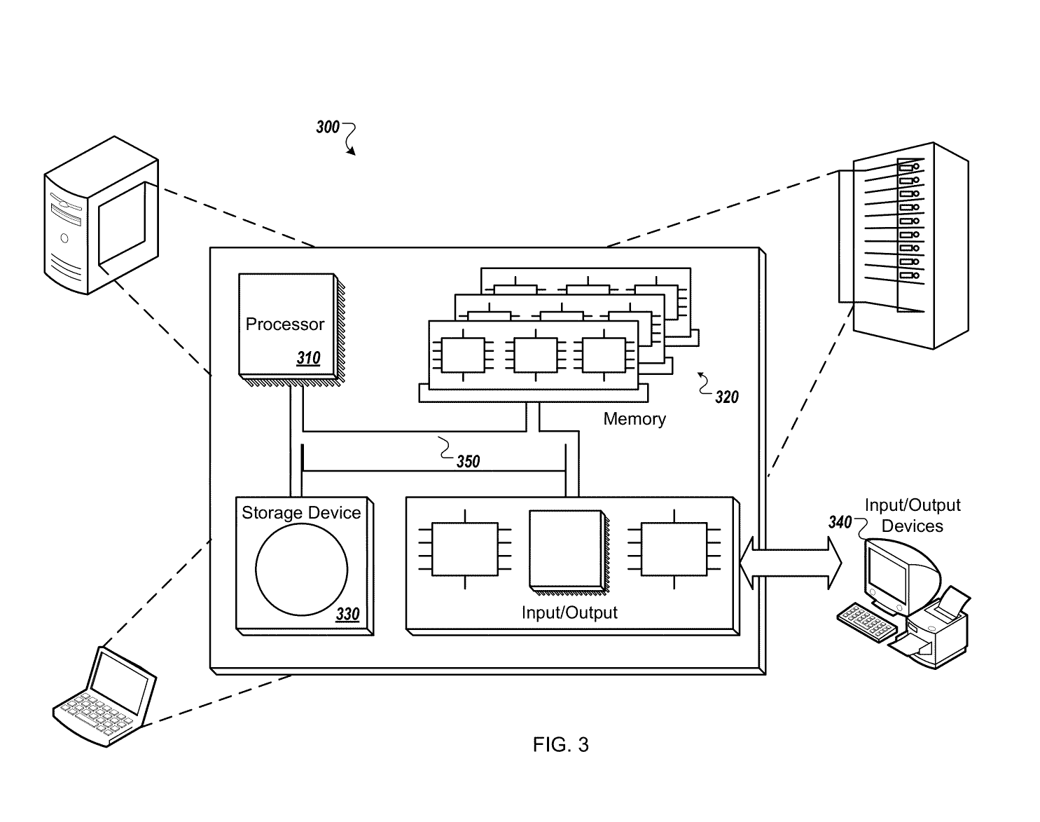

FIG. 3 is a schematic diagram of an example of a generic computer system 300. The system 300 can be used for the operations described above. For example, the system 300 may be included in either or all of the aggregator's server system 106, the financial institution server systems 112 and 114, or the user device 104.

The system 300 includes a processor 310, a memory 320, a storage device 330, and an input/output device 340. Instructions that implement operations associated with the methods described above can be stored in the memory 320 or on the storage device 330. Each of the components 310, 320, 330, and 340 are interconnected using a system bus 350. The processor 310 is capable of processing instructions for execution within the system 300. In some implementations, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In some implementations, the memory 320 is a computer-readable medium. In some implementations, the memory 320 is a volatile memory unit. In another implementation, the memory 320 is a non-volatile memory unit.

The storage device 330 is capable of providing mass storage for the system 300. In some implementations, the storage device 330 is a computer-readable medium. In various different implementations, the storage device 330 may be a floppy disk device, a hard disk device, an optical disk device, a tape device, or any other information storage medium.

The input/output device 340 provides input/output operations for the system 300. In some implementations, the input/output device 340 includes a keyboard and/or pointing device. In another implementation, the input/output device 340 includes a display unit for displaying graphical user interfaces with touch and/or eye tracking capabilities for input.

FIG. 4 illustrates an example interface 400 displaying collaborative financial planning options available to a user in a financial collaboration group. The region 400 includes options for managing the user's personal finances. For example, the user can select an option to manage the user's financial accounts, manage payments made to payees, manage bill reminders, manage the user's financial collaboration groups, or view communications with other users in the financial collaboration group. Selection of a particular option would open an interface dedicated to that option. The second region 400 can be arranged to display options in a windowpane format so that each option is presented in a respective windowpane.

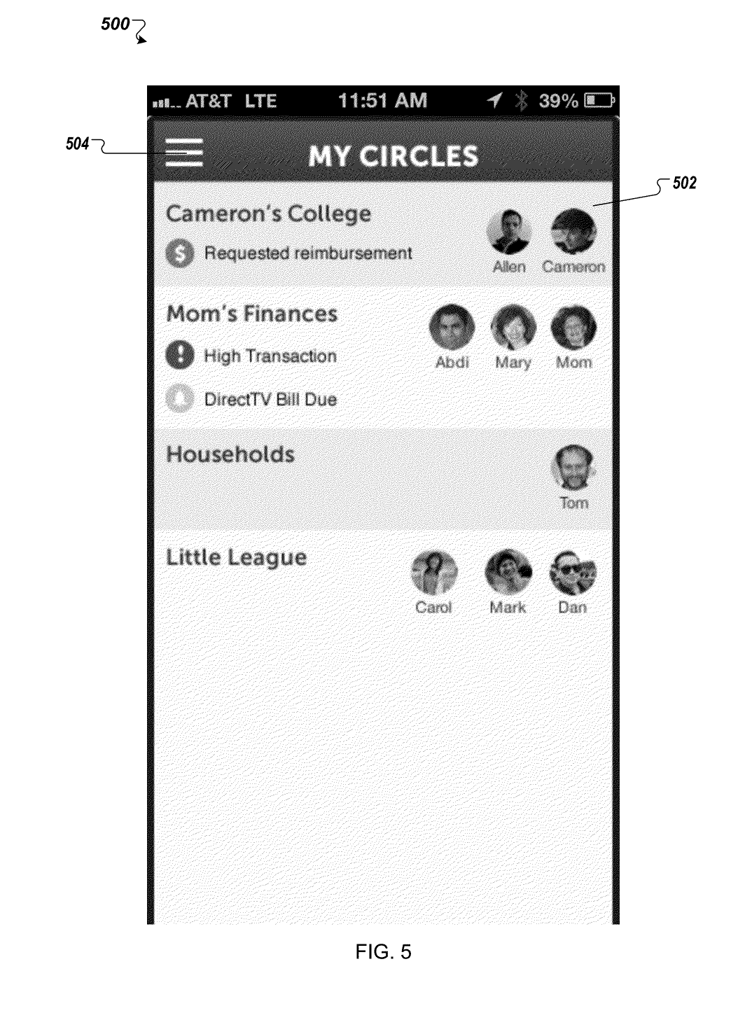

For example, selection of “My Circles” 402 can present the user with their financial collaboration groups, described below with reference to FIG. 5.

“My Stuff” 404 provides an interface describing the user's financial accounts. For instance, the interface can provide the user with a listing of their financial accounts at different financial institutions, a listing of bills, recent transactions, credit card accounts, investments, rewards, loans, and mortgages.

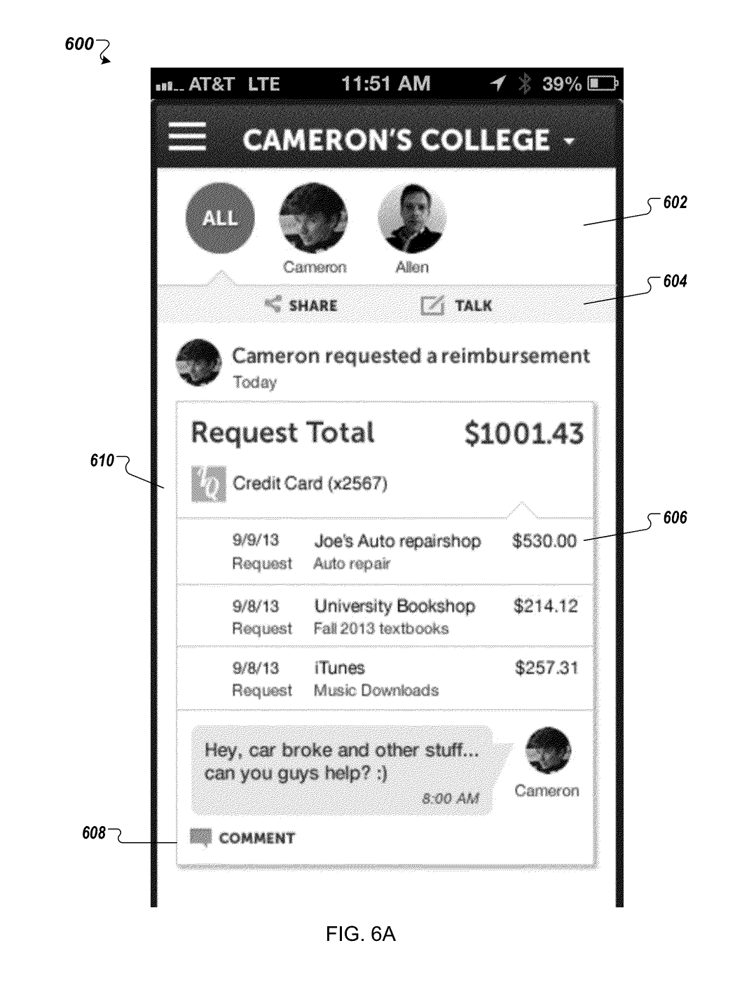

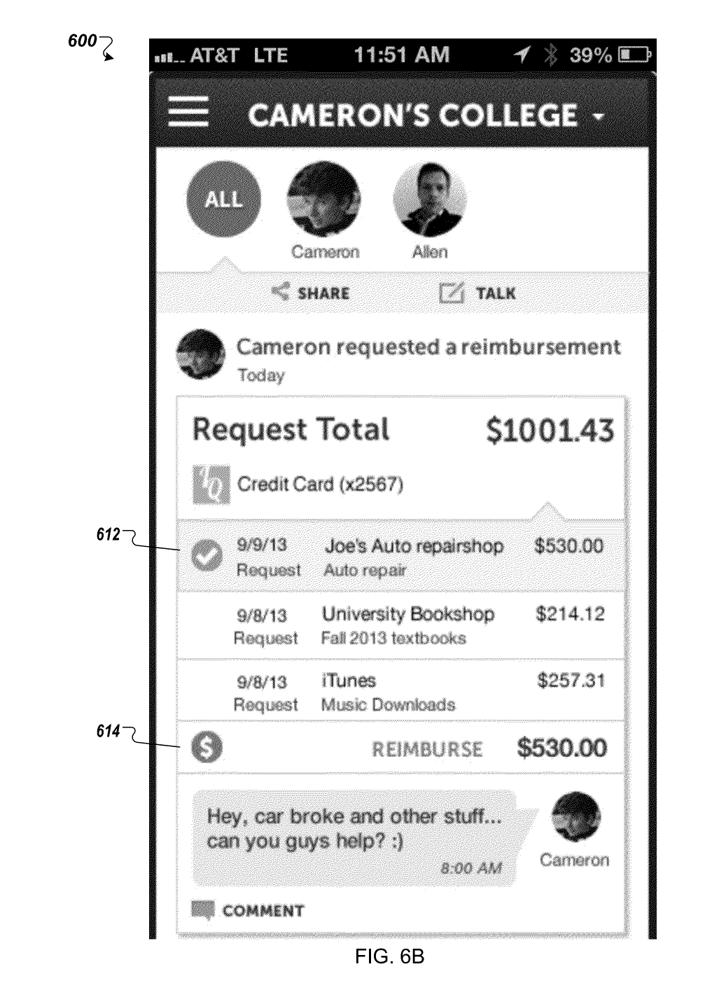

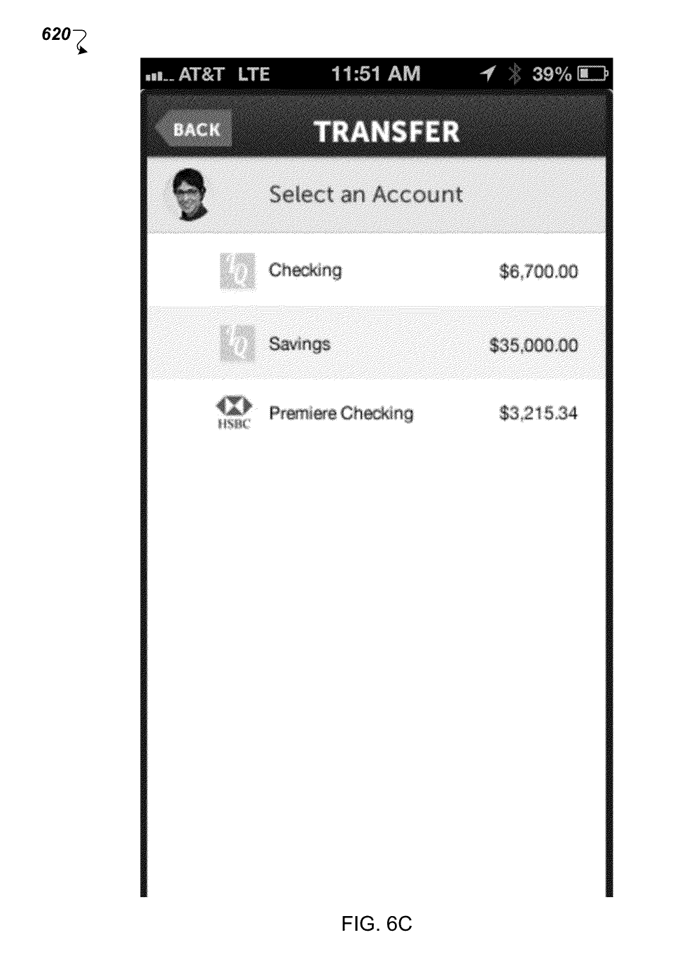

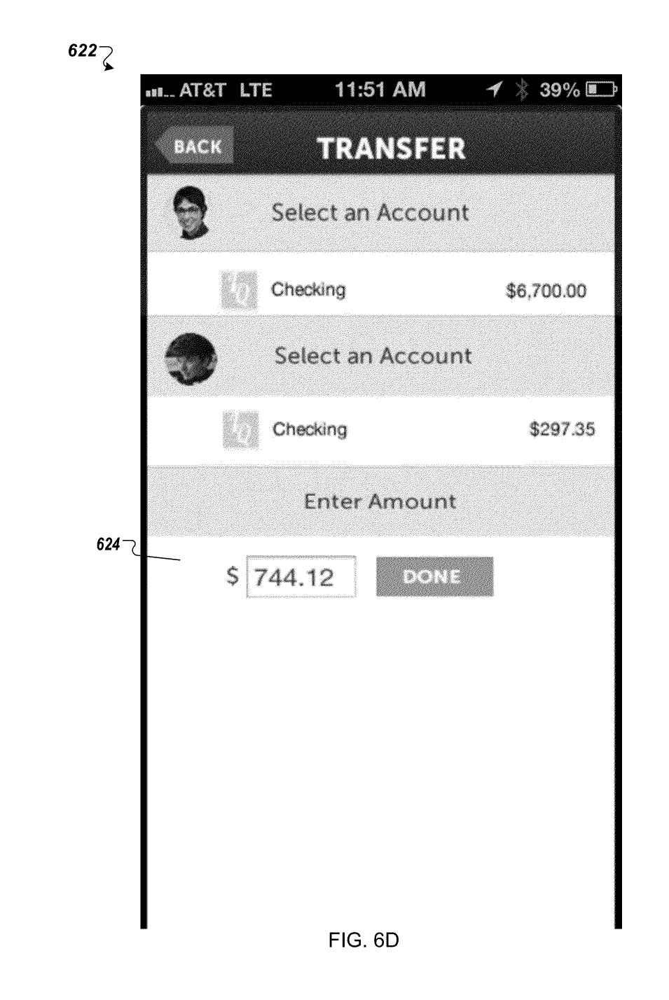

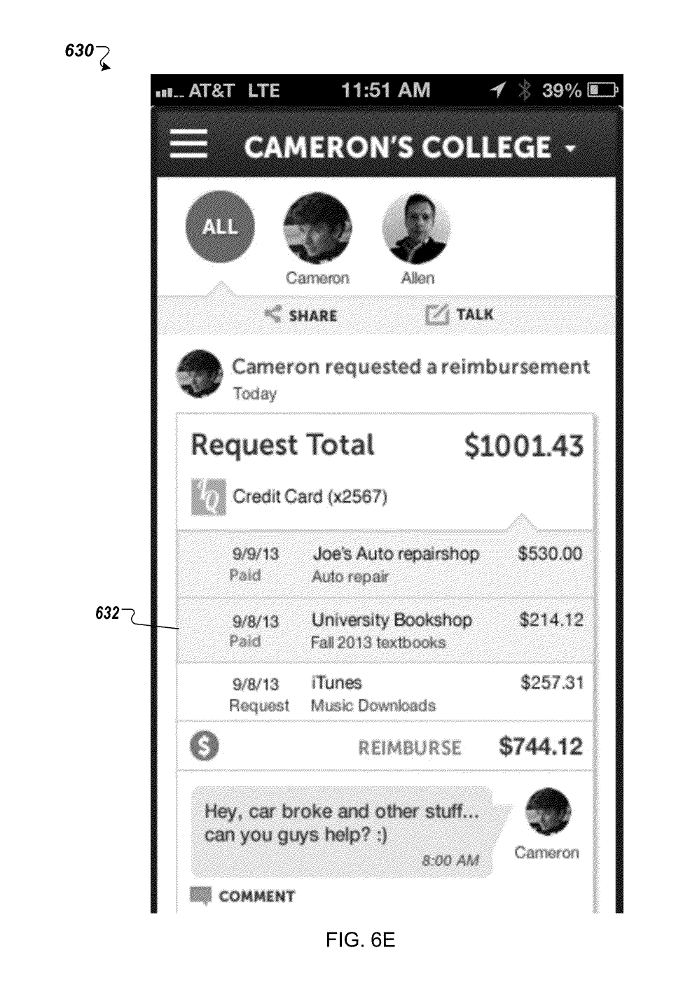

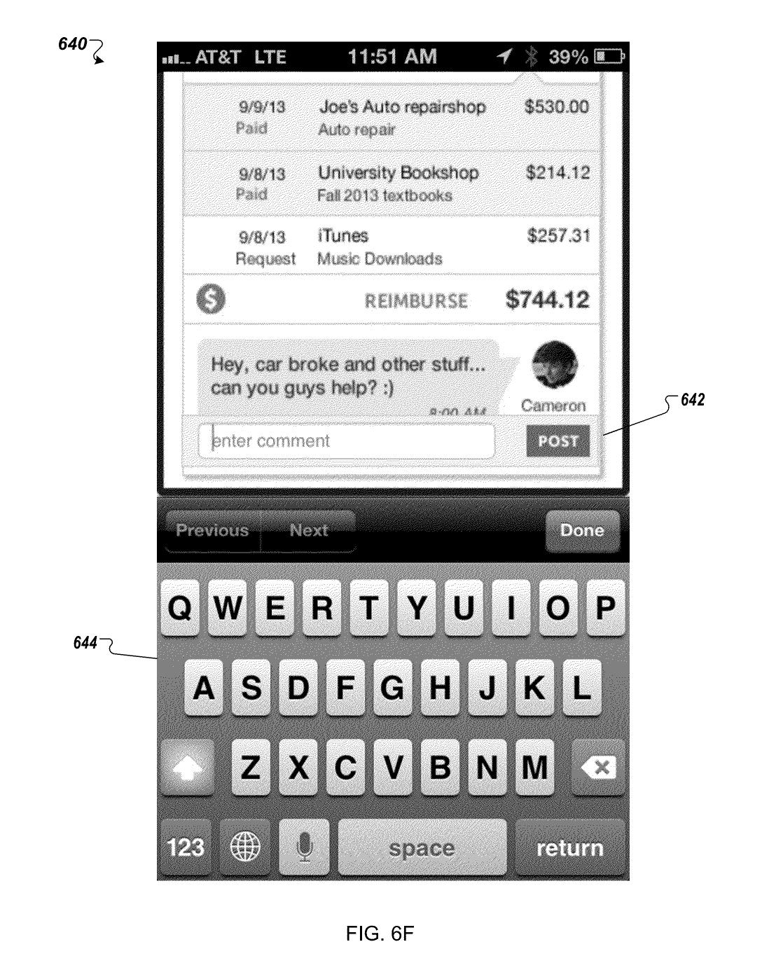

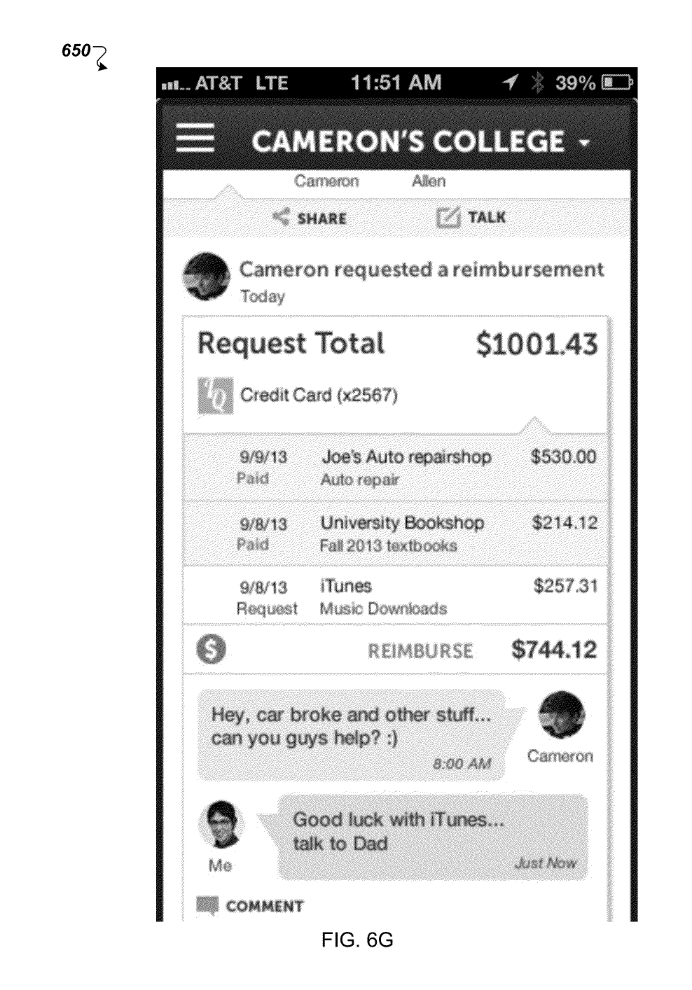

“Send Money” 406 provides an interface to transfer money to another user, or in some implementations a non-user, and is described below with reference to FIGS. 6C and 6D.

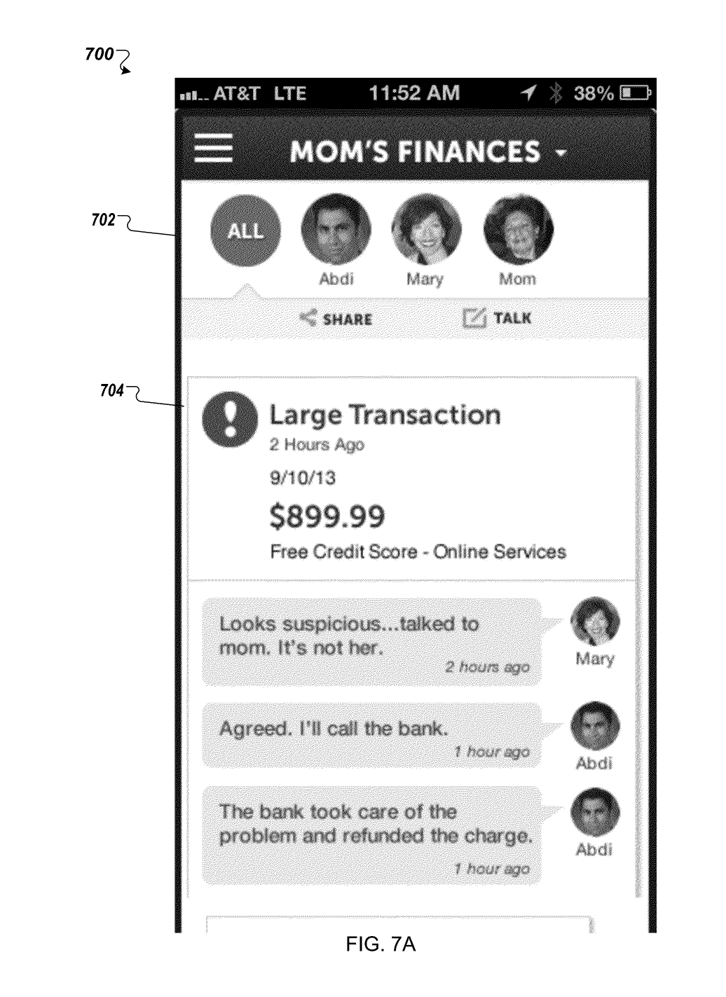

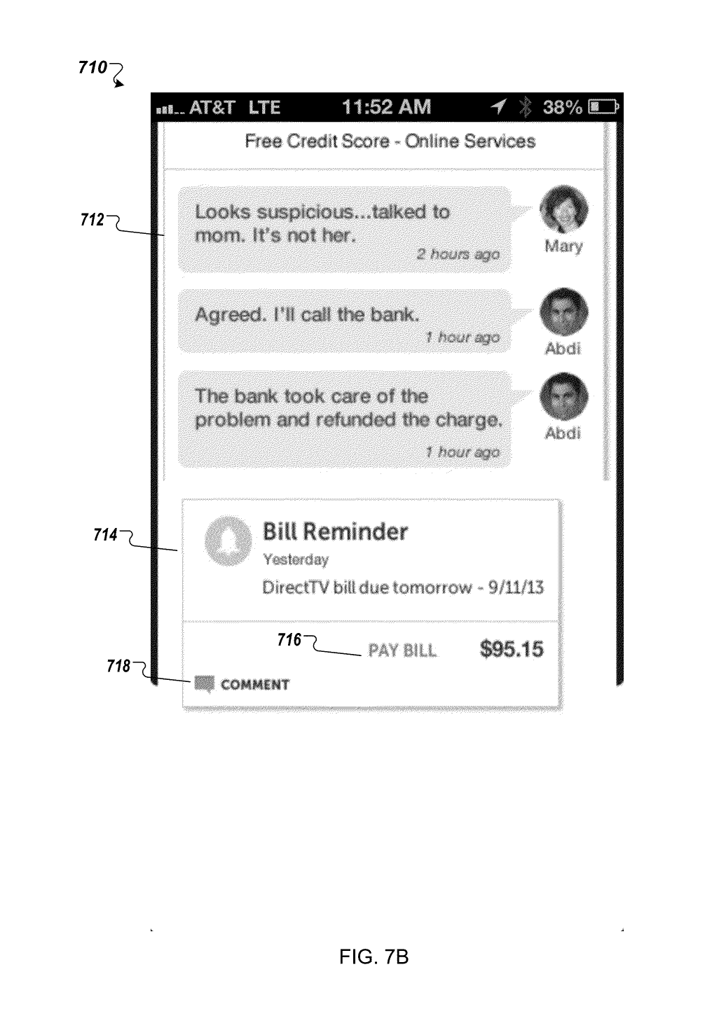

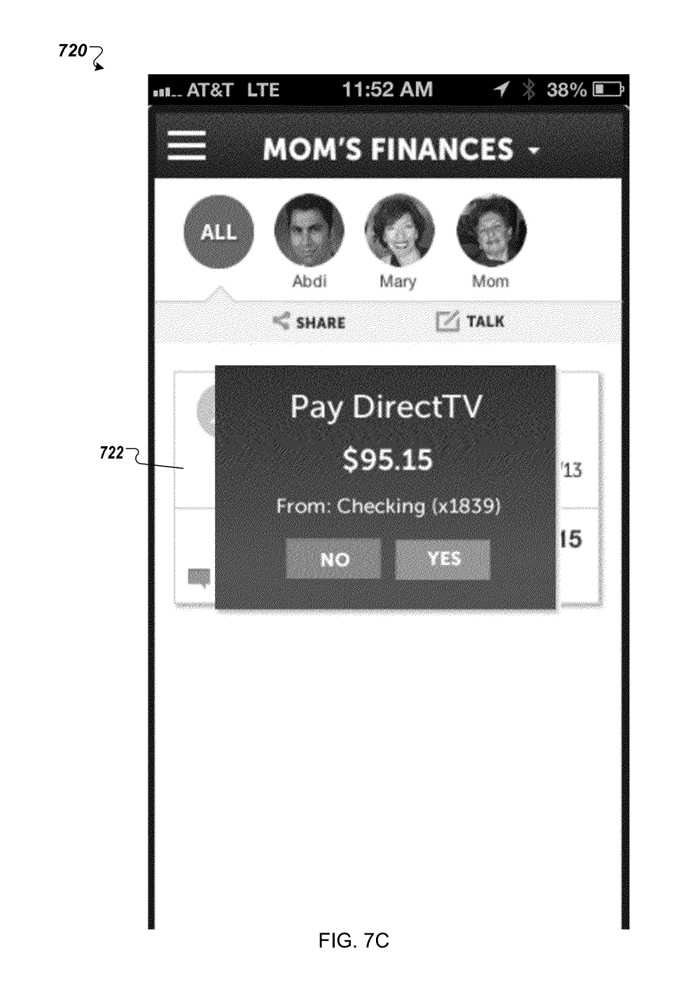

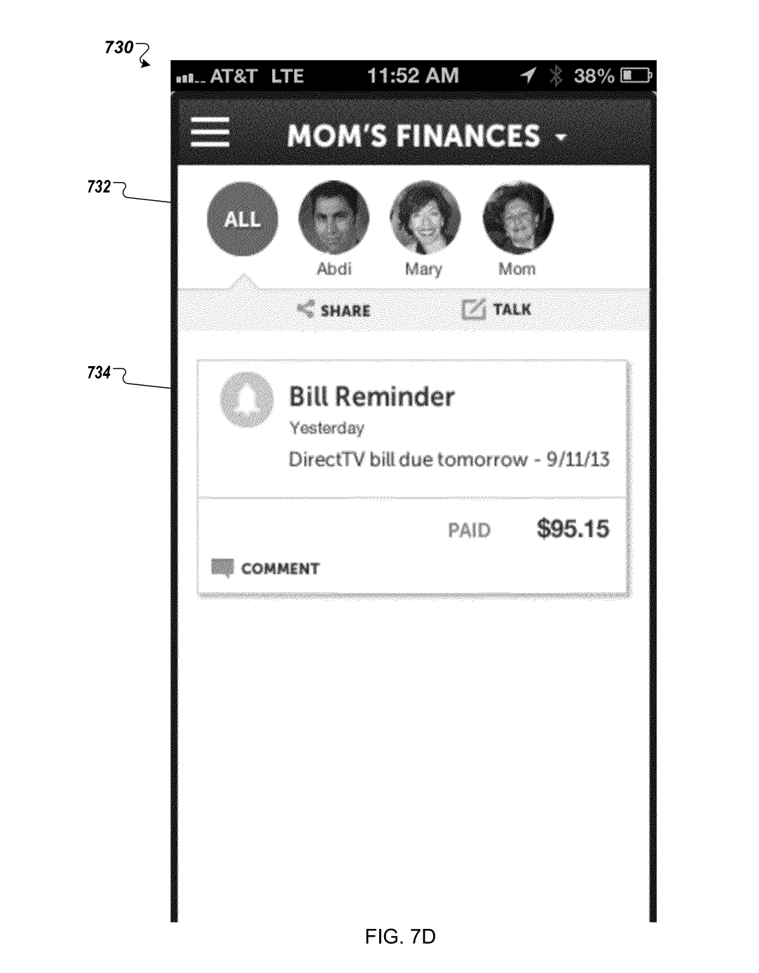

“Reminders” 408 provides the user with financial reminders or alerts. The reminders can be user created, generated by the system automatically, or received from financial institutions or other users. In some implementations the system provides functionality for the user to create reminders related to their financial accounts, financial collaboration groups, or any arbitrary subject. Creating a reminder is described below, with reference to FIG. 7B.

“Chat” 410 provides a chat interface and a listing of prior chats involving the user. Chats can be initiated generally, or can be associated in reference to a particular financial transaction. The chat interface can include a listing of all chats, and chats separated by, e.g., user, financial collaboration group, financial account, or any arbitrary user-designated separation.

“Mail” 412 provides a mail interface to send and receive e-mail, and store electronic bills, receipts, and other mail or email from an electronic financial institution. For example, a financial institution can provide a user with an electronic bill instead of physically mailing the bill to the user's address. The electronic bill can be automatically gathered by the system and presented to the user in the mail interface.

FIG. 5 illustrates an example interface displaying financial collaboration groups. In FIG. 5, the interface 500 displays, for each financial collaboration group, e.g., 502, data describing the financial collaboration group. The data can include, for example, a name for each user in the financial collaboration group, a user representation of a user, e.g., a thumbnail image of the user for each user in the financial collaboration group, a name of the financial collaboration group, and one more status messages for the financial collaboration group. Examples of status messages include financial account balance alerts, e.g., “low balance alert” and “high transaction alert”, helpful tips, e.g., “you should consider setting a budget”, and notifications, e.g., “you have a reimbursement request” and “electric bill due”.

A button 504 can activate a drop-down menu that permits selection of various actions, such as adding or deleting a financial collaboration group.

FIG. 6A illustrates an example interface 600 displaying a reimbursement request for a financial transaction. The interface 600 includes a first region 602 and a second region 604. The first region 602 displays data describing the financial collaboration group including, for example, thumbnail images of users in the financial collaboration group.

The second region 604 displays details describing the reimbursement request including, for example, a request total for the reimbursement request, a listing of financial transactions included in the reimbursement request, and a conversation between the user and the user that sent the reimbursement request.

The operations that can be performed with the reimbursement request include, for example, sharing the reimbursement request or initiating a conversation about the reimbursement request with the user that sent the reimbursement request or a different user. Once shared, other users can view and perform various operations on the shared financial transactions, as described above. The user can also select the communicate option to initiate chats with the user that sent the reimbursement request or one or more of the other users in the financial collaboration group. The chats can be initiated generally or can be associated in reference to a particular financial transaction, e.g., the reimbursement request. This chat can be archived and available for retrieval in the future.

Further, the user can interact with the interface 600 to select one or more individual transactions, e.g., 606, included in the reimbursement request to pay or to initiate a conversation about a transaction. The interface 600 displays other details 610 about the financial transaction including, for example, a request total, an itemized listing of financial transactions in the reimbursement request, respective descriptions of the financial transactions, e.g., merchant information, a total for the financial transaction, date of the financial transaction, and an explanatory description of the financial transaction. The interface 600 displays conversations about the financial transaction, e.g., reimbursement request. For example, the interface 600 displays a comment 608 provided by the user sending the reimbursement request, which can provide context for the financial transaction. The user can select a comment option 608 to post a comment.

FIG. 6B illustrates an updated example interface 600 displaying a reimbursement request for a financial transaction. In FIG. 6B, the interface 600 has been updated after a user selection of a financial transaction 612 for reimbursement. Once the financial transaction 612 has been selected, the interface 600 is updated to show a reimbursement amount 614 that reflects the total amount for the selected financial transactions.

FIG. 6C illustrates an example interface 620 displaying options for paying a reimbursement request for a financial transaction. The interface 620 provides the user with a listing of the user's financial accounts that can be used to satisfy payment of the reimbursement request. The user can select one of the financial accounts from which funds for paying the reimbursement request will be withdrawn. The user can optionally select more than one financial account and can specify a respective fund amount that should be withdrawn from the selected financial accounts.

FIG. 6D illustrates an example interface 622 displaying transfer details for a reimbursement request for a financial transaction. The interface 622 describes the user's financial account from which funds will be withdrawn and a destination financial account of the user that sent the reimbursement request into which the funds will be deposited. The user can interact with the interface 622 to specify a total amount 624 to be paid for the reimbursement request and can authorize the payment by selecting a submit button, e.g., “done”.

FIG. 6E illustrates an example interface 630 displaying a reimbursement request for a financial transaction. In FIG. 6E, the interface 630 has been updated to reflect that the user has paid for reimbursement for two of the three financial transactions 632 for reimbursement.

FIG. 6F illustrates an example interface 640 for posting a comment in response to a reimbursement request for a financial transaction. In FIG. 6F, the user is posting a comment 642 in response to the reimbursement request. When posting a comment, the interface 640 can display a virtual keyboard overlay 644 through which the user can input the comment.

FIG. 6G illustrates an example interface 650 displaying a status of a reimbursement request for a financial transaction. The interface 650 displays information about the reimbursement request. For example, the interface 650 displays a request total for the reimbursement request, provides a listing of financial transactions included in the reimbursement request, particular financial transactions that were paid by the user, a total amount that was reimbursed by the user, and a conversation between the user and the user that sent the reimbursement request.

FIG. 7A illustrates an example interface 700 for managing a third-party's financial transactions, e.g., an elderly parent and adult children. The interface 700 includes a first region 702 describing a financial collaboration group, e.g., users in the financial collaboration group, user representations of the users, and respective names and descriptions of the users. The interface 700 also includes a second region 704 that provides details describing the parent's financial accounts, e.g., financial transactions, alerts, and reminders, as described above.

In this example, the third-party is an elderly parent that has a financial collaboration group with her adult children. The children are assisting the parent in management of her finances. As described above, the collaborative financial planning management system 106 can generate alerts for user's financial transactions and can display the alerts to users in a financial collaboration group. In FIG. 7A, the interface 700 displays an alert indicating that a large financial transaction has occurred in the parent's financial account, including, for example, details about the financial transaction, e.g., a time or date when the transaction occurred, a total amount for the transaction, and a description of the merchant that charged the transaction. The children can interact with the interface 700, for example, using their respective user devices, to post comments discussing the transaction with others in the financial collaboration group.

FIG. 7B illustrates an example interface 710 for managing a third-party's financial transactions. The interface 710 is displaying comments 712 that were posted in response to an alert, as described in FIG. 7A. The interface 710 is also displaying a bill reminder 714, e.g., as a pop-up overlay. The bill reminder describes details for a bill that is due including, for example, a bill due date, an amount due, and a description of the merchant that sent the bill. A user in the financial collaboration group, e.g., one of the children, can select a pay bill option 716 to pay the bill from the parent's financial accounts, or their own financial account, and can submit a comment to other users in the electronic relationship using the option 718.

FIG. 7C illustrates an example interface 720 for paying a third-party's financial bill. The interface 720 shows a confirmation window 722 asking a user to confirm payment of the bill in response to the user selecting the pay bill option described in reference to FIG. 7B. The confirmation window 722 provides details describing the payment including, for example, a merchant name that submitted the bill, an amount of funds being paid, description of the user's financial account from which the funds will be transferred, and a confirmation button for confirming the payment.

FIG. 7D illustrates an example interface 730 displaying a status of a bill payment for a third-party's financial bill. The interface 730 includes a first region 732 and a second region 734. The first region 732 describes a financial collaboration group, as described above. The second region 734 describes details of the bill payment including, for example, a merchant name that submitted the bill, an amount of funds that were paid, description of the user's financial account from which the funds will be transferred, and a comment option that users in the financial collaboration group can select to comment on the bill payment.

FIG. 8 illustrates an example interface 800. The interface 800 includes a first region with selectable options including the financial collaboration group 802, people involved in the relationship 804, and context options 806, e.g., specific information about the financial collaboration group. The interface 800 further includes a second region responsive to user selections in the first region, and can include the specific information about the financial collaboration group associated with a selected context option, e.g., individual transactions as shown in 808.

For example, in illustrative example 800 “Mary's College” is the name of the financial collaboration group. The people involved in the financial relationship appear as representations in the interface 802; optionally if the people are users, the system can provide images, icons, or names of them. Each representation can be selected by a user, causing the second region to be updated with information solely related to the selected user, e.g., information uploaded or shared by the selected user, or information relevant to the selected user. In some implementations the representations can also include the user 816 of the user device, and a “Shared Space” option, e.g., an option to provide information related to all users.

A user can navigate away from this interface using the menu option 810. The menu option 810 allows for access to a different financial collaboration group, or access to other system provided operations, e.g., viewing the user's financial accounts, transferring money, adding new users to a financial relationship and so on. In some implementations menu option 810 provides the user with the interface 400, described above with reference to FIG. 4.

Specific information about the financial collaboration group can be displayed in the second region by selecting among context options 806, e.g., providing the user with real-time chat (“Talks”), Alerts, specific transactions of the financial relationship, budgets, upcoming or received bills, documents related to the financial relationship, images uploaded by users, non-users, or financial institutions, and any receipts. In some implementations the specific information associated with a context option can be stored by the financial collaboration server system 106 in a database. The specific information can be a grouping of elements in the database, for example each element can be a specific transaction, a specific image, a specific document related to the financial relationship, a specific alert, a specific user entered text string in a chat window, and so on. In some implementations, the specific information associated with a context option can be stored generally by the server system 106 and labeled or marked with the context option name. The financial collaboration server system 106 can then locate the specific information when a user selects a context option.

Upon selection of a context option, the interface updates the second region to display the elements of the information about the financial relationship. For example, as shown in interface 800, “Trans”, e.g., specific transactions, is selected. The information displayed is therefore elements of the specific transactions, such as a charge for “$898.89” from user “Mary.”

As discussed above, the second region is responsive to both a context option, and a user selection of a user representation. In some implementations, upon selecting a user representation, the user 816 is provided with the specific information associated with a context option that has been shared by the selected user. In other implementations, the specific information seen by the user 816 is any information associated with a context option that is related to the selected user, e.g., information is automatically shared with the user 816 without the selected user having to specifically share it. Additionally the user can select “Shared Space”, providing all information associated with the context option, e.g., all information uploaded, or in some implementations automatically shared, by any of the users in the electronic relationship.

For example, the interface can include actions 812, e.g., paying for a specific transaction “Send $898.89” in illustrative example 800. This action 812 is displayed upon a user selection of a context option, e.g., “Trans” or specific transactions as shown in example 800. If for example, the user had selected “eBills”, e.g., past or upcoming bills, the action 812 could update to “reimburse”, providing a method to reimburse another user for a bill.

Furthermore, the second region includes the ability to comment 814 on an element of information associated with a selected context option. In illustrative example 800, user “Mary” has commented “Can you please pay for my textbooks?” about her own transaction 808. The user 816 can comment on this question, and perform the action 812, e.g., “Send $898.89”, using the same interface 800.

Additionally, the interface 800 allows for actions to be performed on a specific element of the information associated with a context option. A general list of actions can be displayed if a user swipes to the left on the second region, e.g., the system registers an input indicating the user started an input at the right side of the interface and moved to the left. A list of actions specific to an element of information associated with a context option can be displayed if a user swipes to the right of the second region, e.g. the system registers an input indicating the user started an input at the left side of the interface and moved to the right.

The general list of actions depends on the financial relationship and selected context option. For instance, in a financial relationship involving parents paying for their son or daughter, a parent swiping to the left of an element of the specific transaction context option will present a request for reimbursement option. In another example, in a financial relationship involving adult children and an elderly parent, a child swiping to the left of an element of the specific transaction context option will present options to call the financial institution, call another person in the financial relationship, and submit a dispute involving the transaction. If the context option is alerts, swiping to the left of a specific alert can remove the alert, or edit the alert to provide a different expiration or notification date.

The specific list of actions depends on the selected context option and selected user representation. For instance, if the selected user representation is the user 816, and the context option is specific transactions, swiping to the right on a specific transaction can share the transaction with everyone in the financial relationship. In another example, if the selected user representation is “Shared Space”, and the context option is specific transactions, budget, alerts, or receipts, swiping to the right can prompt the user to add a comment about the transaction. Furthermore, swiping to the right on an alert can allow for editing of the frequency of the alert, or the notification date of the alert.

FIG. 9 illustrates an example interface 900. The interface 900 is an interface displayed to a user of a user device. In some implementations the interface 900 is a user interface of an application executing on the user device, e.g., a mobile device, a hybrid, or a wearable device. The interface receives information from, and provides information to, a computer system, e.g., the financial collaboration server system 106, connected to the user device, e.g., over the Internet. The interface 900 identifies the name of the user 902 of the user device, and can also include a user identifier, e.g., an image, of the user. The interface 900 includes multiple selectable options, e.g., selectable by the user, such as “My Inbox” option 908, “My Accounts” option 906, and “My Circles” option 904. Additionally, the interface 900 includes a selectable button 910, e.g., “+”, that is configured to allow a user to create a circle, e.g., a financial collaboration group described above with reference to FIG. 1 and FIG. 2. Creating a circle is described below, with reference to FIG. 10.

The interface of FIGS. 9-15 can be presented in the application, as described above, and can be interacted with by a user. The user can interact with the application by touching the user device, e.g., with one or more fingers of the user, providing input to the user device, e.g., keyboard, mouse, audio input.

Selecting the “My Inbox” option 908 provides an interface that includes comments received from other users, e.g., to remind a user about any money he/she owes, described below with reference to FIG. 15. Additionally, the provided interface can include information identifying upcoming bills, received money from other users, and requests to join a circle created by another user.

Selecting the “My Accounts” option 906 provides an interface that includes information identifying financial accounts aggregated by the selecting user. Aggregating financial accounts is described above with reference to FIG. 1.

Selecting the “My Circles” option 904 provides an interface that includes information identifying circles the selecting user is included in. An example of a circle is described below, with reference to FIG. 11.

FIG. 10 illustrates an example interface 1000 for creating a circle. A circle, e.g., a financial collaboration group, includes two or more users that can each share financial information with the remaining users. In creating a circle, a user can specify a name, in the region 1002, for the circle. In some implementations the name is a global name for the circle across all users in the circle, e.g., each user device of a user in the circle displays the same circle name. In some other implementations the name can be modified by any user in the circle, e.g., each user device can display a different user name. When creating a circle, a user can also provide a description, in the region 1004, of the circle. This description is provided to a system in communication with the application, e.g., the financial collaboration server system 106, and stored along with information identifying the circle. After creation of the circle, each user added to the circle receives the description of the circle, and an option to join the circle.

A user can add other users to the circle by selecting the “Add Members” option 1006. Upon selecting this option, the user interface 1000 provides a list of contacts of the user, e.g., contacts stored on the user's user device, or contacts stored in a contacts list of a social network. Adding a contact is described above, with reference to FIG. 2.

A user can configure the circle to either be an open or closed circle by selecting option 1008, e.g., an invitation vote type can include an open circle and a closed circle. In an open circle, any user that is a member of the circle can add a further user to the circle, subject to approval by the other users, e.g., all the other users, presently in the circle. In some implementations a threshold percentage of users in the circle have to agree to include a new user, e.g., 25%, 50%, 75%, and so on. In a closed circle, only the user that created the circle is permitted to add new users in the circle. In some implementations, if a user wants to add a new user to the circle, information identifying that user is presented to all other users. The information can include, e.g., a name of the user, an e-mail account of the user, a description of the user, a career of the user, e.g., obtained from a social network, and so on.

FIG. 11 illustrates an example interface 1100 that includes information related to a circle. The interface 1100 includes an identifier of the interface 1100, e.g., the interface 1100 displays “My Circles” 1108. Additionally the interface 1100 includes a selectable option 1109 that upon selection provides the interface 900 to a selecting user. The interface 1100 includes a region presenting information identifying the particular circle being presented, e.g., “Fish.” A user can view different circles by interacting with this region, e.g., a user can swipe left or right on the region to receive information identifying other circles the user is included in. The user can swipe left or right on the user device presenting the interface 1100.

The interface 1100 includes an ordered list of events relevant to the circle. Each event is displayed inside a respective panel, e.g., panels 1102, 1110, and 1120, that identify information to a user. Events can be of different types, e.g., request for reimbursement, comment, information identifying that a new user is invited to the circle, information identifying that a new user wants to join the circle, information identifying upcoming transactions or bills, information identifying that a financial account has been shared with the circle, information identifying a statement of a financial account that has been shared, and so on. The panels can be interacted with by a user, e.g., a user can swipe on a panel, a user can select a panel or a selectable option in the panel, to effect respective functionality by the user. For instance, a user can select a panel identifying a request for reimbursement, e.g., a user can long press the panel. After selection, the panel can present information identifying the financial transactions involved in the request.

In the example, panel 1102 identifies a first event, e.g., a request for reimbursement from another user in the circle, panel 1110 identifies a second event, e.g., a bill 1110, e.g., a credit card statement, and panel 1120 identifies a third event, e.g., information identifying that a financial account has been shared.

The interface 1100 presents different types of events as they are generated by a system, e.g., the financial collaboration server system 106. For instance, if a user in the circle wants to receive a reimbursement for one or more financial transactions, the interface 1100 is updated to include the event. The interface 1100 presents events that include identifying comments received from users. Additionally an event can be an invitation from a user in the circle to a user outside of the circle to join the circle. The interface 1100 can present information identifying the invitation e.g., an identifier of the user outside the circle, information related to the user, an option for users in the circle to approve of the inclusion of the outside user.

The presented events can depend on a user device displaying the event. For instance, a first user in the circle can transfer money to a second user in the circle, e.g., transfer $5. An event can be generated by a system for presentation on each user's user device. The event presented on the first user's user device can display information identifying the transfer of $5 to the second user. The event presented on the second user's user device can display information identifying the receipt of $5 from the first user.

In the example of FIG. 11, the ordered list of events is displayed inside respective panels, e.g., cards. In some other implementations the ordered list of events can be presented in other visual forms, including a plain table, and so on.

The panel 1102 identifying a request for reimbursement includes an amount owed to a user, e.g., $7.22. In some implementations, the panel 1102 can display a different amount on each user device of a user that owes a portion of an overall amount of money to a particular user. That is, if a first user is owed $50, the panel 1102 can display $25 on a second user's user device, $10 on a third user's user device, and $15 on a fourth user's user device. In some implementations the amount of money displayed on each user device can represent the total amount owed by all users, e.g., the second, third, and fourth users. Each user can then select a “Settle Up” option 1106 to pay an amount of money they determine they owe. In some implementations the user that's owed money can specify an amount of money that each user owes him/her. Additionally, the user that's owed money can automatically have the amount of money equally split by the number of users, e.g., the financial collaboration server system 106 can compute a total for each user. A user interface presented upon a user selecting the “Settle Up” option 1106 is described below, with reference to FIG. 15.

The panel 1102 identifying the request for reimbursement includes a selectable object 1104 that provides functionality to comment on the request for reimbursement. In some implementations comments about the request can be displayed below the request 1102, for all users in the circle to view. In some other implementations, comments about the request can be displayed upon a user selecting the “Comment” selectable object 1104. Upon selection by a user, a chat window is displayed that includes comments from any user that has provided a comment on the request for reimbursement.

A user can share a bill with other users in the circle, as displayed in panel 1110. In the example of FIG. 11, a user has shared a credit card bill for the amount of $2,111.57. The user interface 1100 includes information identifying the bill, including a date the bill was received by a user, the type of bill it is, e.g., “CREDIT CARD Ending in 0882,” and a date the bill is due, e.g., “Pay by: 09/22/2014. In some implementations one user can pay the entirety of the bill, and submit a request for reimbursement for their payment.

Panel 1120 displays information identifying a financial account that has been shared, e.g., a credit card, with other users in the circle. Sharing a financial account means that other users can perform operations on financial information in the financial account. The operations can include viewing financial transactions in the shared financial account, viewing a bill related to the shared financial account, and transferring money to the financial account, transferring money into the financial account.

A user can receive information identifying all financial accounts that have been shared with the circle, by interacting with the down arrow option 1122. For instance a user can swipe downwards on the arrow option 1122, and be presented with identifiers of financial accounts that have been shared, e.g., names of the financial accounts. Additionally, the user can receive a balance of the financial accounts, and identifiers of users in the circle that shared each financial account.

The interface 1100 includes a selectable object 1130 that displays a list of functionality available to users in the circle, described below with reference to FIG. 12.

FIG. 12 illustrates an example interface 1200 that displays functionality available to users in a circle. Users in a circle can share one or more financial accounts, create a request for money owed for a financial transaction, pay money owed to other users, provide comments for display in the interface 1200, and archive information in the circle.

A user can share a financial account by selecting a “Share” option 1202. The user can share a financial account, e.g., a checking account, credit card account, savings account, or a bill, e.g., a water bill, an Internet bill, an electricity bill, rent, or the user can share an expense, e.g., a cash expense incurred by the user. The shared financial account is displayed in the interface 1200, e.g., the shared financial account described above in FIG. 11. Upon selection of the “Share” option 1202, the user is provided with an interface to select a financial account, described below with reference to FIG. 13.

A user can identify financial transactions they are owed money for by selecting a “Split Request” option 1204. Upon selection of the “Split Request” option 1204, the selecting user is presented with an interface to select one or more financial transactions, and one or more users, or a circle that includes users, to receive a request for reimbursement related to the selected financial transactions. Selecting the “Split Request” option 1204 is described below with reference to FIG. 14.

A user can identify money that they owe to other users in a particular circle, or to any user in any circle, by selecting a “Settle Up” option 1206. Upon selection of the “Settle Up” option 1206, the selecting user is presented with a list of users, e.g., user identifiers, that he/she owes money to, and also a list of users, e.g., user identifiers, that owe the selecting user money. In some implementations, the users that owe money can be in a particular color, e.g., red, orange, green, and the users that owe the selecting user money can be in a different color, e.g., black, purple, and so on. The selecting user can select a particular user identifier, and provide a payment for the money he/she owes. Selecting the “Settle Up” option 1208 is described below, with reference to FIG. 15.

FIG. 13 illustrates an example interface 1300 for sharing a financial account. The interface 1300 displays information identifying aggregated financial accounts 1304 of a user. Aggregating financial accounts is described above, with reference to FIG. 1. The interface 1300 includes a “Bills” options 1306 to display bills, e.g., the user can aggregate financial accounts at companies that provide services to the user in return to money, and a “My Expenses” option 1308, e.g., the user can manually input expenses such as cash expenses. The user can select a financial account to share, e.g., the selectable area 1304 displaying “Chase—Credit Card”, which can be shared with users in a circle.

FIG. 14 illustrates an example interface 1400 to request a reimbursement from one or more users. A user can identify a user to split one or more financial transactions with, e.g., by selecting an option 1412 to identify a circle, by selecting an option 1414 to identify particular users, and also the financial transactions to include, e.g., by selecting an option 1422 to identify particular financial transactions from a financial account 1422, by selecting an option 1424 to identify particular bills, by selecting an option to identify particular expenses 1426. Upon selection of a circle, a selecting user is presented with a list of all circles they are included in. Upon selection of a contact, the selecting user can be presented with an interface to select a user, e.g., contacts included in a contacts list stored on the selecting user's user device, or contacts from a contacts list on a social network. In some implementations upon selection of a contact, the selecting user is presented with the most commonly interacted with users.

In some implementations, upon selection of option 1422, e.g., option displaying “Transactions from Accounts,” the selecting user is presented with a list of aggregated financial accounts. The selecting user can then select a particular financial account, and view a list of financial accounts in the selected account. Then, the user can identify one or more financial transactions to include in a request for reimbursement.

In some implementations, upon selection of option 1422, e.g., option displaying “Transactions from Accounts,” the selecting user is presented with a list of financial transactions determined by a system, e.g., the financial collaboration server system 106, to be relevant to the circle. For instance, the system can identify transactions related to a road trip, and display those transactions. If the selecting user wants to view more financial transactions, he/she can select an option to view the entirety of financial transactions.

Similarly, upon selection of option 1424, e.g., option displaying “Transactions from Bills,” the selecting user is presented with a list of bills, e.g., phone bill, Internet bill, Rent, and so on. Selecting option 1426, e.g., option displaying “Transactions from my expenses,” displays any expenses, e.g., cash expenses, that are manually inputted by the selecting user.

FIG. 15 illustrates an example interface 1500 for viewing money owed to a user and money owed by the user. The interface 1500 includes user identifiers 1502, e.g., a name of a user and an image of the user, with respective amounts of money 1504 in a selectable area. As described above, the users that owe money can be in a particular color, e.g., red, orange, green, and the users that owe the selecting user money can be in a different color, e.g., black, purple, and so on.

Upon selection, in the selectable area, of a user identifier 1502 of a user that the selecting user owes money to, the selecting user can be presented with an interface to transfer money. The interface can include a list of aggregated financial accounts of the selecting user, and the selecting user can identify one or more financial accounts to pull money from. The interface can then provide information to a system, e.g., the financial collaboration server system 106, identifying the transfer of money. The system can provide information to the selected financial accounts to transfer money to a financial account of the user the selecting user owes money to, e.g., a routing number and account number of the financial account, a debit card number of the financial account.

Upon selection, in the selectable area, of a user identifier 1502 of a user that the selecting user is owed money from, the selecting user can be presented with an interface to remind the user about the money. For instance, the interface can include functionality to send a comment to the user, send an e-mail to the user, or send a text message to the user. The comment can be provided to, for instance, the inbox of the user that owes money, e.g., the interface presented upon selecting the “My Inbox” option 908 described above in FIG. 9.

The interfaces described above, e.g., interfaces in FIGS. 4-15, include examples names of options, panels, financial accounts, user names, and so on. It should be understood that all names are examples, and can be altered without any change in the functionality. For instance, the example interface of FIG. 11, e.g., interface 1100, includes “My Circles.” This can be altered to “My collaboration group,” or any arbitrary name and not affect the functionality described in this document.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. The computer storage medium can be a machine-readable storage device, a machine-readable storage substrate, a random or serial access memory device, or a combination of one or more of them. Alternatively or in addition to being encoded on a storage medium, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer program product, comprising instructions encoded in a non-transitory computer readable medium to cause a processor of a device to:
display in a first region of a display of the device a name of a currently selected financial collaboration group out of a plurality of financial collaboration groups to which a user of the device is a member;
receive data representing a plurality of events associated with the currently selected financial collaboration group, each event of the plurality of events being one of a plurality of types;
simultaneously with the display of the name of the currently selected financial collaboration group in the first region of the display of the device, display in a second region of the display of the device an ordered list of the plurality of events, wherein each item in the ordered list includes a visual indicia of an event type for the event corresponding to the item; and
select a different financial collaboration group of the plurality of financial collaboration groups in response to a touch input in the first region of the display of the device.

2. The computer program product of claim 1, wherein the ordered list is ordered by time of the event.

3. The computer program product of claim 1, comprising instructions to, simultaneously with the display of the ordered list in the second region, display in a third region of the device display a user selectable option to create an event associated with the currently selected financial collaboration group.

4. The computer program product of claim 2, wherein the user selectable option to create the event comprises a drop-down menu including options to add a transaction and to add a comment to the plurality of events.

5. The computer program product of claim 1, wherein the plurality of event types comprise a transaction type, the transaction type indicating a financial transaction shared with the financial collaboration group by a member of the financial collaboration group.

6. The computer program product of claim 5, comprising instructions to display, within an item of the transaction type, a user-selectable option to add a comment to the event.

7. The computer program product of claim 5, wherein the plurality of event types comprise a reimbursement request type, the reimbursement request type indicating a financial transaction to be reimbursed by the user of the device.

8. The computer program product of claim 5, comprising instructions to display, within an item of the reimbursement request type, a user-selectable option to add a comment to the event.

9. The computer program product of claim 5, comprising instructions to display, within an item of the reimbursement request type, a user-selectable option to settle up the transaction.

10. The computer program product of claim 5, wherein the plurality of event types comprise an invitation vote type, the invitation vote type indicating an invitation to a new user to join the financial collaboration group.

11. A method comprising:
receiving, at a server system from a plurality of users of a respective plurality of user devices, data indicating that the users consent to join a financial collaboration group;
identifying, in the server system, financial information associated with one or more financial accounts of a first user of the plurality of users;
receiving, at the server system from a first user device of the first user, information identifying financial information to be shared by the first user; and
providing, by the server system, for presentation on each user device of the plurality of user devices other than the first user device, respective information identifying the shared financial information.

12. The method of claim 11, wherein receiving data indicating that the users consent to join a financial collaboration group comprises:
receiving, from a second user, a request to create a financial collaboration group, the request specifying the plurality of users; and
receiving, from each of the plurality of users, data indicating consent to join the financial collaboration group.

13. The method of claim 11, wherein the shared financial information comprises a financial account, and wherein providing respective information to each user device other than the first user device comprises:
providing, for presentation on the user device, respective information identifying a plurality of financial transactions included in the shared financial account.

14. The method of claim 13, wherein each user device receives the plurality of financial transactions.

15. The method of claim 11, further comprising:
providing respective information for presentation on a user device in response to receiving a request from the user device.

16. The method of claim 11, wherein the shared financial information comprises a particular financial transaction, and wherein providing respective information to each user device different from the first user device comprises:
providing, for presentation on the user device, a respective request for reimbursement of the particular financial transaction.

17. The method of claim 16, further comprising:
receiving, from a second user, information identifying that the second user is to transfer money to the first user.

18. The method of claim 17, further comprising:
obtaining information identifying an account number and a routing number of a financial account of the second user;
obtaining information identifying an account number and a routing number of a financial account of the first user; and
transferring money from the second user to the first user.

19. The method of claim 16, further comprising:
receiving, from a second user, a comment comprising text entered by the second user; and
providing, for presentation on each user device of the plurality of user devices, the comment.

20. The method of claim 16, wherein the respective request for reimbursement includes a respective amount of money owed by the user of the user device to the first user.

21. The method of claim 16, further comprising:
receiving a request, from the first user, to create a request for reimbursement;
providing, for presentation on the first user device, information identifying a plurality of financial transactions included in the financial information of the first user; and
receiving, from the first user, a selection of the particular financial transaction.

22. The method of claim 21, further comprising:
providing, for presentation on the first user device, information identifying one or more financial accounts of the first user;
receiving, from the first user, a selection of a particular financial account; and
providing, for presentation on the first user device, the plurality of financial transactions, wherein the plurality of financial transactions are included in the particular financial account.

23. The method of claim 11, further comprising:
receiving, from the first user, a request to create a shared budget with a second user of the plurality of users, the request specifying a budget name, one or more categories of financial transactions to be included in the shared budget, a budget timeframe, and a threshold budget amount;
identifying financial information associated with one or more financial accounts of the second user;
generating, based on the request, a shared budget for the one or more categories of financial transactions; and
providing, for presentation on the first user device and a second user device of the second user, information identifying a status of the shared budget, wherein the status includes an amount of budget remaining in the shared budget for the budget timeframe.

24. The method of claim 23, further comprising:
identifying, from respective financial transactions included in the first user's financial accounts and the second user's financial accounts, one or more financial transactions that are categorized as the one or more categories of financial transactions to be included in the shared budget;
determining a total amount for the one or more identified financial transactions;
computing an updated amount of budget by subtracting the total amount from the amount of budget remaining; and
providing, for presentation on the first user device and the second user device, information identifying the updated amount of budget remaining in the shared budget for the budget timeframe.

25. The method of claim 24, further comprising:
determining that the total amount exceeds the threshold budget amount; and
providing, for presentation on the first user device and second user device, respective alerts indicating that the shared budget has been exceeded.

26. The method of claim 23, further comprising:
identifying, from respective financial transactions included in the first user's financial accounts and the second user's financial accounts, one or more financial transactions that are categorized as the one or more categories of financial transactions to be included in the shared budget;
determining a utilization of the shared budget with respect to the budget timeframe; and
providing, for presentation on the first user device and second user device, information identifying the utilization of the shared budget.

27. The method of claim 11, further comprising:
receiving, from the first user, a request to create a shared goal with a second user of a second user device, the request identifying information comprising:
a shared goal name, a first amount to be contributed to the shared goal, a first time interval for how often the first amount should be contributed to the shared goal, and a particular financial account for depositing funds for the shared goal;
receiving, from the second user, a second amount to be contributed to the shared goal and a second time interval for how often the second amount should be contributed to the shared goal; and
providing, for presentation on the first user device and the second user device, information identifying the shared goal, wherein the information identifies the particular financial account and an amount of funds that have been deposited in the particular financial account.

28. The method of claim 27, further comprising:
determining that the first time interval for how often the first amount should be contributed to the shared goal has been satisfied; and
transferring, from a financial account of the first user, the first amount to the particular financial account.

29. The method of claim 28, wherein the first time interval is a one-time transfer, a daily transfer, a weekly transfer, a monthly transfer, or a yearly transfer.

30. The method of claim 27, further comprising:
determining that the second time interval for how often the second amount should be contributed to the shared goal has been satisfied; and
transferring, from a financial account of the second user, the second amount to the particular financial account.

31. A computer-implemented method comprising:
providing an interface to a first user of a user device, wherein the interface comprises:
a plurality of user representations associated with a respective plurality of users, wherein the plurality of users are included in a same financial collaboration group with the first user and one or more financial accounts of the first user are shared with the plurality of users,
a plurality of context options, wherein each context option is associated with respective information about the financial collaboration group,
a chat interface to display text from one or more users of the plurality of users, and
a display area including information associated with one or more context options;
receiving a selection of one or more context options;
updating the interface with information associated with the selected context options; and
providing the updated interface to the first user.

32. The method of claim 31, further comprising:
receiving a selection of a user representation; and
updating the interface with information associated with the selected context options related to the user associated with the selected user representation.

33. The method of claim 31, wherein the plurality of user representations includes a user representation associated with the first user and a user representation associated with all users included in the financial collaboration group.

34. The method of claim 31, wherein each user representation of the plurality of user representations is an image of the associated user.

35. The method of claim 32, wherein information associated with the selected context options related to the user of the selected user representation is information shared by the user associated with the selected user representation.

36. The method of claim 32, wherein the context options comprise reminders, specific transactions of the financial collaboration group, budgets, bills, documents related to the financial collaboration group, images, receipts.

37. The method of claim 32, further comprising:
receiving an input representing the user swiping in a first direction;
determining an option list to provide to the user based at least on the selected context options, wherein each option of the option list is associated with an action performed by the user device; and
providing the list of options to the user.

38. The method of claim 37, wherein one of the selected context options is specific transactions of the financial collaboration group and the option list comprises submitting a request for reimbursement, telephoning a user, telephoning the creditor of the transaction.

39. The method of claim 37, wherein one of the selected context options is reminders and the option list comprises removing the reminder.

40. The method of claim of claim 32, further comprising:
receiving an input representing the user swiping in a second direction;
determining an option list to provide to the user based at least on the selected context options, wherein each option of the option list is associated with an action performed by the user device; and
providing the list of options to the user;

41. The method claim 31, further comprising:
receiving, from a second user of the plurality of users, data describing one or more of the second user's financial accounts.

42. The method of claim 41, wherein the first user is included in a relationship category with the plurality of users that identifies one or more operations that can be performed by each user on the first and second user's financial accounts.

43. A computer-implemented method comprising:
identifying, on a user device, a second user to be included in a financial collaboration group with a first user of the user device, wherein one or more of the first user's financial accounts are shared with the second user;
receiving, at the user device, a selection of a relationship category from a plurality of relationship categories, wherein each relationship category identifies one or more operations that can be performed by the second user on the first user's financial accounts; and
receiving, at the user device, an indication that second user has consented to be included in the financial collaboration group.

44. The method of claim 43, further comprising:
obtaining, from the user device, a contact list of the first user, wherein the contact list comprises data identifying a plurality of contacts;
identifying the contact from the contact list;
determining a relationship category from the data identifying the contact; and
providing the determined relationship category to the first user of the user device.

45. The method of claim 44, further comprising:
obtaining data from a social network identifying the second user as a social network contact of the first user;
determining a relationship category from the data identifying the contact; and
providing the determined relationship category to the first user of the user device.

46. The method of claim 44, further comprising:
providing the plurality of relationship categories to the user.
